(19) United States
(12) Patent Application Publication
(10) Pub. No.: US 2017/0036399 A1
(43) Pub. Date: Feb. 9, 2017

(54) 3D printer

(71) Applicant: Well Smart Electronics Limited, Kowloon (HK)

(72) Inventor: Lai Man Cheung, Kowloon (HK)

(73) Assignee: Well Smart Electronics Limited

(21) Appl. No.: 15/224,816

(22) Filed: Aug. 1, 2016

(30) Foreign Application Priority Data
Aug. 6, 2015 (HK) 15107566.2

(51) Int. Cl. B29C 67/00; B33Y 50/02; B33Y 40/00; B33Y 30/00

(52) U.S. Cl. CPC B29C 67/0085; B29C 67/0055; B29C 67/0088; B29C 67/0092; B33Y 30/00; B33Y 50/02; B33Y 40/00

(57) ABSTRACT

A 3D printer includes a frame, a printing head connected to the frame and movable with respective to the frame, and a table assembly connected to the frame. The table assembly includes an object table adapted to support an object to be printed during a printing operation. The table assembly is adapted to move relative to the frame at least between a storage position and an operational position. Method of changing the 3D printer from the storage position to the operational position is also shown. Since the state of the printer can be changed on a flexible basis for the purposes of storage and printing, the printer according to the present invention can be carried away easily by the user using a single hand, like a suitcase. On the other hand, the full functionality provided by the 3D printer is still preserved.

### FIELD OF INVENTION

This invention relates to three-dimensional object printers, and in particular internal structures of three-dimensional object printers and working principles thereof.

### BACKGROUND OF INVENTION

Three dimensional (3D) object printing is one of the hottest new technology areas nowadays, which provides a brand new way of fabricating three dimensional objects based on computer 3D modeling or 3D scanning from a real object. Applications for 3D printing are found for example in artistic design, architecture, engineering and construction (AEC), automobile, aeronautics and astronautics, dental and medical industries, education, geographic information systems, civil engineering, and so on. As the 3D printing technology evolves rapidly, 3D printers are now also affordable for small office and home users for ad-hoc 3D printing jobs.

Most existing 3D printers are designed to be fixed in a place after the user purchased or otherwise acquired the printer, just like common office photocopying machines. Due to the large size of the 3D printers they are usually not moved once they are put in the desired place and started to be used for 3D printing. As a result, maintenance or transportation of the 3D printers poses much difficulty for the user. It would usually need more than one person to carry the 3D printers to a different place. For users who need to achieve 3D printing in different premises, they will need to purchase multiple 3D printer units to be suited in these premises, which is costly. Also, it is impossible for the user to do 3D printing during business travels since the 3D printers are fixed in place.

The bulky size of 3D printers also results in difficulties in storage of the 3D printers if they will not be used for a period of time. The traditional cubic shape of the 3D printer means that a large space must be preserved to store the 3D printer.

### SUMMARY OF INVENTION

In the light of the foregoing background, it is an object of the present invention to provide an alternate 3D printer which eliminates or at least alleviates the above technical problems.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention, in one aspect, is a 3D printer, including: a frame; a printing head connected to the frame and movable with respective to the frame; and a table assembly connected to the frame. The table assembly includes an object table adapted to support an object to be printed during a printing operation. The table assembly is adapted to move relative to the frame at least between a storage position and an operational position.

Preferably, the frame defines a three-dimensional form factor. In the operational position, the table assembly extends beyond the form factor of the frame. In the storage position, the table assembly is substantially received within the form factor of the frame.

More preferably, the table assembly is defined by at least a first table dimension, and the form factor of the frame is defined at least by a first frame dimension and a second frame dimension. When the table assembly is in the storage position, the first table dimension is parallel to the first frame dimension and shorter than the first frame dimension. When the table assembly is in the operational position, the first table dimension is parallel to the second frame dimension and longer than the second frame dimension.

Even more preferably, the table assembly is rotatable with respect to the frame. The frame includes a top plate, a base plate, and at least one side wall. In the storage position the table assembly is substantially parallel to the side wall of the frame. In the operational position the table assembly is substantially parallel to and extends beyond the base plate of the frame.

In one implementation, the table assembly is connected to the frame by two hinges, the table assembly further including a table base on which the object table is supported; the two hinges coupled to the table base on two lateral edges thereof; the lateral edges being parallel to the first table dimension.

Preferably, on the two lateral edges of the table base, there are configured two grooves respectively. The hinges engage with the grooves and are adapted to slide in the grooves, thereby allowing the table base to move linearly with respect to the hinges.

More preferably, the hinges are configured to allow sliding of the hinges in the grooves only when the table base is rotated relative to the hinges to a predetermined angle.

In one variation, each of the hinges further includes a hinge pin and a stopping member fixed to the hinge pin. The table base is rotatable with respect to the stopping member. The stopping member is placed outside of the groove and is incapable of sliding in the groove when the table base is rotated relative to the stopping member to an angle different from the predetermined angle. The stopping member is received inside the groove and is capable of sliding in the groove when the table base is rotated relative to the stopping member to the predetermined angle.

In another variation, at least a part of the stopping member has a cross-section in trapezoidal shape.

In a further variation, the hinge pin is a screw.

In an exemplary embodiment of the present invention, the 3D printer further includes a locking device coupled between the table assembly and the frame to lock the table assembly from moving relative to the frame.

Preferably, the table assembly further includes a table base on which the object table is supported. The locking device includes a locking pin which is movably received within thorough holes formed on the frame and the table base respectively. The locking pin is capable of moving into or leaving the thorough hole of the table base to enable locking and unlocking of the table assembly.

In a further exemplary embodiment of the present invention, the 3D printer further includes a handle configured on the frame for a user to carry the 3D printer.

In a further exemplary embodiment of the present invention, the 3D printer further includes a touch screen; the touch screen connected to a controller of the 3D printer.

In a further exemplary embodiment of the present invention, the 3D printer further includes a storage device adapter adapted to receive the connection of an external storage device.

Preferably, the storage device adapter is a SD card reader.

Preferably, the storage device adapter is connected to a controller of the 3D printer. The controller is capable of reading 3D model files from the storage device for printing by the 3D printer.

In a further exemplary embodiment of the present invention, the printer head of the 3D printer further includes: a heating chamber for melting filament fed into the printer head; a nozzle connected to and in communication with the heating chamber, the nozzle configured to output the melted filament; an active cooling device coupled to the heating chamber; and a passive cooling device coupled to the heating chamber.

Preferably, the active cooling device is a fan.

Preferably, the fan is configured to face directly the passive cooling device.

More preferably, the passive cooling device is a heat sink directly connected to the heating chamber.

In one implementation, the heat sink has generally a cylindrical shape.

In a further exemplary embodiment of the present invention, the object table of the 3D printer further includes a first layer of non-deformable material and a second layer of heating material placed underneath the first layer. The first layer is adapted to support directly an object to be printed by the 3D printer. The heating material is connected to a power source to generate heat required for keeping the object on a fixed location on the object table.

Preferably, the non-deformable material is thermal conductive.

More preferably, the non-deformable material is borosilicate glass.

In one variation, the borosilicate glass has a thickness of 3 mm.

In another variation, the heating material is a thin film.

Preferably, the heating material is polyimide heating film.

According to a second aspect of the present invention, a method of configuring a 3D printer from a storage state to an operational state, including the steps of unlocking an table assembly of the 3D printer which is in a storage position from a frame of the 3D printer, where the frame includes a top plate, a base plate, and at least one side wall, and the table assembly is substantially parallel with the side wall of the frame in the storage position; rotating the table assembly with respect to the frame until the table assembly becomes substantially parallel with the base plate of the frame; linearly moving the table assembly to an operational position; and locking the table assembly in the operational position.

Preferably, the table assembly is locked to the frame in the storage position by a locking device which is adapted to be actuated by a user.

More preferably, the table assembly further includes a table base on which the object table is supported. The locking device includes a locking pin. The locking pin is movably received within thorough holes formed on the frame and the object table respectively. In the unlocking step, the user moves the locking pin to leave the thorough hole of the table base to enable unlocking of the table assembly.

In one variation, the table assembly further includes a table base on which the object table is supported. The table base is connected to the frame by two hinges, the two hinges coupled to the table base on two lateral edges thereof.

Preferably, on the two lateral edges of the table base, there are configured two grooves respectively. The hinges engage with the grooves and are adapted to slide in the grooves. In the moving step, the table base is moved by the user linearly with respect to the hinges.

In another variation, each of the hinges further includes a hinge pin and a stopping member fixed to the hinge pin. The stopping member is rotatable with respect to the groove. During the rotating step, the stopping member is placed outside of the groove and is incapable of sliding in the groove when the object table is not rotated to an angle to be substantially parallel to the base plate. The stopping member is received inside the groove and is capable of sliding in the groove in the moving step, when the object table is rotated to be substantially parallel to the base plate.

Preferably, at least a part of the stopping member has a cross-section in trapezoidal shape.

More preferably, the hinge pin is a screw.

According to a third aspect of the present invention, a method of configuring a 3D printer from an operational state to a storage state, including the steps of: unlocking an table assembly of the 3D printer which is in a operational position, where a frame of the 3D printer includes a top plate, a base plate, and at least one side wall, and the table assembly is substantially parallel with the base plate of the frame in the operational position; linearly moving the table assembly from the operational position to an intermediate position; rotating the object table with respect to the frame from the intermediate position, until the object table becomes substantially parallel with the side wall of the frame; and locking the object table in the storage position.

Preferably, the table assembly is locked to the frame in the storage position by a locking device which is adapted to be actuated by a user.

More preferably, the table assembly further includes a table base on which the object table is supported. The locking device includes a locking pin. The locking pin is movably received within thorough holes formed on the frame and the table base respectively. In the unlocking step, the user moves the locking pin to enter the thorough hole of the table base to lock the table assembly.

In one variation, the table assembly further includes a table base on which the object table is supported. The table base is connected to the frame by two hinges. The two hinges are coupled to the table base on two lateral edges thereof.

In another variation, on the two lateral edges of the table base, there are configured two grooves respectively. The hinges engage with the grooves and being adapted to slide in the grooves. In the moving step, the table base is moved by the user linearly with respect to the hinges.

Preferably, each of the hinges further includes a hinge pin and a stopping member fixed to the hinge pin. The stopping member is rotatable with respect to the groove. During the rotating step, the stopping member is placed outside of the groove and is incapable of sliding in the groove when the object table is not rotated to an angle to be substantially parallel to the base plate. The stopping member is received inside the groove and is capable of sliding in the groove in the moving step, when the table base is rotated to be substantially parallel to the base plate.

Preferably, at least a part of the stopping member has a cross-section in trapezoidal shape.

More preferably, the hinge pin is a screw.

According to a fourth aspect of the present invention, a printer head of a 3D printer includes a heating chamber for melting filament fed into the printer head; a nozzle connected to and in communication with the heating chamber; an active cooling device coupled to the heating chamber; and a passive cooling device coupled to the heating chamber. The nozzle configured to output the melted filament.

Preferably, the active cooling device is a fan;

More preferably, the fan is configured to face directly the passive cooling device.

In one variation, the passive cooling device is a heat sink directly connected to the heating chamber.

In another variation, the heat sink has generally a cylindrical shape.

According to a fifth aspect of the present invention, an object table of a 3D printer includes a first layer of non-deformable material; the first layer adapted to support directly an object to be printed by the 3D printer; and a second layer of heating material placed underneath the first layer. The heating material is connected to a power source to generate heat required for keeping the object on a fixed location on the object table.

Preferably, the non-deformable material is thermal conductive.

More preferably, the non-deformable material is borosilicate glass.

In one variation, the borosilicate glass has a thickness of 3 mm.

In another variation, the heating material is a thin film.

Preferably, the heating material is polyimide heating film.

According to a sixth aspect of the present invention, a method of resuming breakpoint printing in a 3D printer includes the steps of: stopping printing during a printing operation of a 3D object; saving a set of printing parameters into a memory of the 3D printer; the set of printing parameters including temperature of the printing head and three-dimensional coordinate of the printing head; making the 3D printer power off; making the 3D printer power on any period of time after step c); reading the set of printing parameters from the memory and configuring the printing head so that the printing head is located at the three-dimensional coordinates and is at the temperature; and; resuming printing of the 3D object.

Preferably, the printing parameter further includes surface temperature of an object table of the 3D printer.

There are many advantages to the present invention. One of the most important advantages is that the 3D printers according to the present invention provide much flexibility to the users for operating the printer and for carrying / moving the printer. Due to the rotatable and slidable design of the table assembly, the 3D printer can be easily changed between the storage state, in which the printer resembles a suitcase shape and can be easily carried away or stored, and the operational state in which the printer is like a conventional 3D printer providing a flat, sufficiently large object table for printing. The users can easily carry the 3D printers according to the present invention to different places as he moves, for example in home, offices, factories, outside environments. The 3D printing is therefore no longer constrained by the location of the printer. The maintenance and transportation of the printers also become more convenient as for instance the user may carry a malfunctioning 3D printer to a nearby service center by himself.

Another advantage of the present invention is that the 3D printers according to the present invention are made for efficient and independent working. In other words, a desktop computer or notebook computer is not essential for doing 3D printing using the 3D printers in the present invention. Rather, the user can easily insert a SD card which carries the 3D model file which contains all the data required for printing the 3D object into the printer, and the printer can start the 3D printing job. In this regard, the touch screen provided in the 3D printer allows the user to perform interactive and intuitive control of the printer, including printer head movement, temperature setting, calibration, breakpoint printing control, etc.

The breakpoint printing function provided by the 3D printers in the present invention makes them even more effective for printing purposes. The user can choose to save an in-progress printing job to the printer and then shut down the printer. When the printer is re-powered on after any time, the user can choose to resume the previous uncompleted printing job by reading the breakpoint saved in the memory of the printer. In this way, there is more flexibility provided to the user as he does not need to wait for a whole, uninterrupted time for the printing to be completed. Rather, he can arbitrarily arrange the time slots for printing.

### BRIEF DESCRIPTION OF FIGURES

The foregoing and further features of the present invention will be apparent from the following description of preferred embodiments which are provided by way of example only in connection with the accompanying figures, of which:

FIG. 1 is a rear side perspective view of a 3D printer in its storage state, according to one embodiment of the present invention.

FIG. 2 is a front side perspective view of the 3D printer in FIG. 1 where the 3D printer is in its storage state.

FIG. 3 is a perspective view of the 3D printer in FIG. 1, where the 3D printer is in its operational state.

FIG. 4 is a front view of the 3D printer in FIG. 1, where the 3D printer is in its operational state.

FIG. 5 shows the perspective view of a portion of the side of the 3D printer in FIG. 1.

FIG. 6 shows the locking key for the table assembly on the upper side of the 3D printer in FIG. 1.

FIG. 7 shows an exploded view of the locking key in FIG. 6.

FIG. 8 shows the cross-sectional view of a portion of the side of the 3D printer in FIG. 1, with the locking key illustrated in the drawing.

FIG. 9 shows the hinge key on the lower side of the 3D printer in FIG. 1.

FIG. 10 shows a standalone view of the hinge key in FIG. 9 and its corresponding stopping member.

FIG. 11a shows the hinge key in FIG. 9 engaged with grooves on the table assembly when the table assembly is in the storage position, with some portion of the side wall omitted for clarity.

FIG. 11b shows the hinge key in FIG. 9 engaged with grooves on the table assembly when the table assembly is in the operational position, with some portion of the side wall omitted for clarity.

FIGS. 12a-12f illustrate the procedure of changing the 3D printer in FIG. 1 from the storage state to the operational state, or vice versa.

FIG. 13 shows an object table of a 3D printer according to one embodiment of the present invention.

FIG. 14 is the exploded view of the object table in FIG. 13.

FIGS. 15a-15c shows a printer head of a 3D printer according to one embodiment of the present invention.

FIG. 15d shows the cross-sectional view of the printer head in FIGS. 15a-15c, with a filament inserted into the printer head.

FIG. 16a shows the main screen of a user interface shown on a touch screen of a 3D printer according to one embodiment of the present invention.

FIG. 16b shows the manual adjusting screen of the user interface in FIG. 16a.

FIG. 16c shows the temperature adjusting screen of the user interface in FIG. 16a.

FIG. 16d shows the system screen of the user interface in FIG. 16a.

FIG. 16e shows the information screen of the user interface in FIG. 16d.

FIG. 16f shows the “About” screen of the user interface in FIG. 16d.

FIG. 17a the changes of the screen during the printing process in the user interface of FIG. 16a.

FIG. 17b shows the printing progress screen of the user interface in FIG. 16a.

FIG. 17c shows the pop-up windows notifying completion of printing in the user interface in FIG. 16a.

FIG. 17d shows the printing job saving screen in the user interface in FIG. 16a.

FIG. 17e shows the in-print adjustment screen in the user interface in FIG. 17b.

FIG. 18a shows the changes of screens for filament loading operation in the user interface in FIG. 16a.

FIG. 18b shows the changes of screens for filament unloading operation in the user interface in FIG. 16a as well as the mechanical operation of the filament unloading.

FIG. 19 shows the block diagram and flow chart of a 3D printer according to one embodiment of the present invention in performing temperature control function.

FIG. 20 shows the block diagram and flow chart of a 3D printer according to one embodiment of the present invention in performing motor speed control function.

FIG. 21 shows the block diagram and flow chart of a 3D printer according to one embodiment of the present invention in performing breakpoint printing resuming function.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention which may not be shown.

As used herein and in the claims, “couple” or “connect” refers to electrical coupling or connection either directly or indirectly via one or more electrical coupling or connection devices unless otherwise stated.

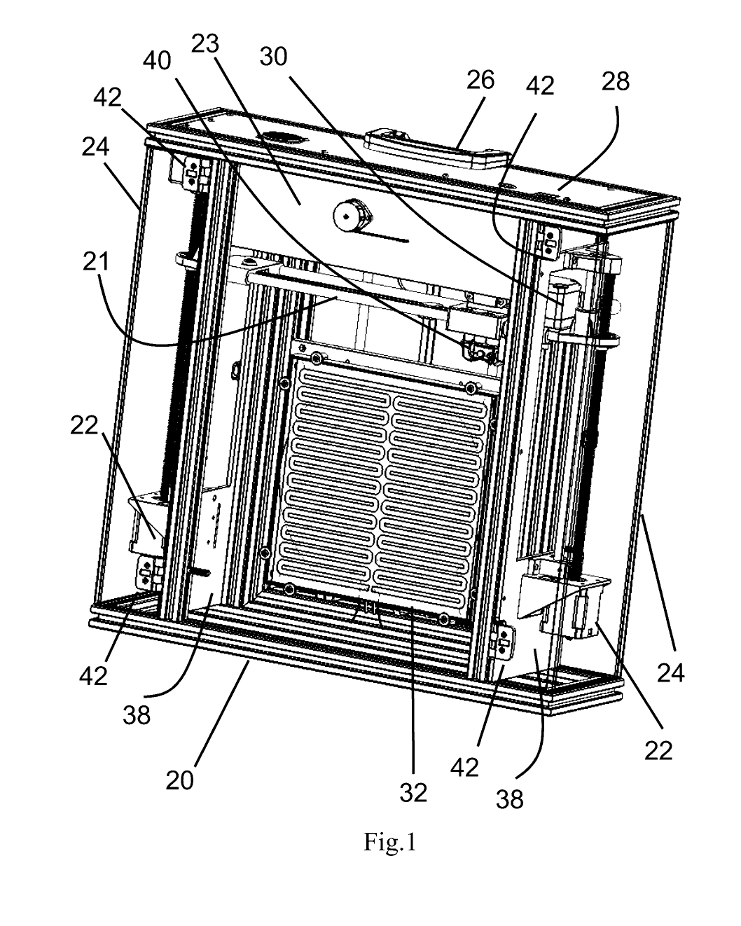

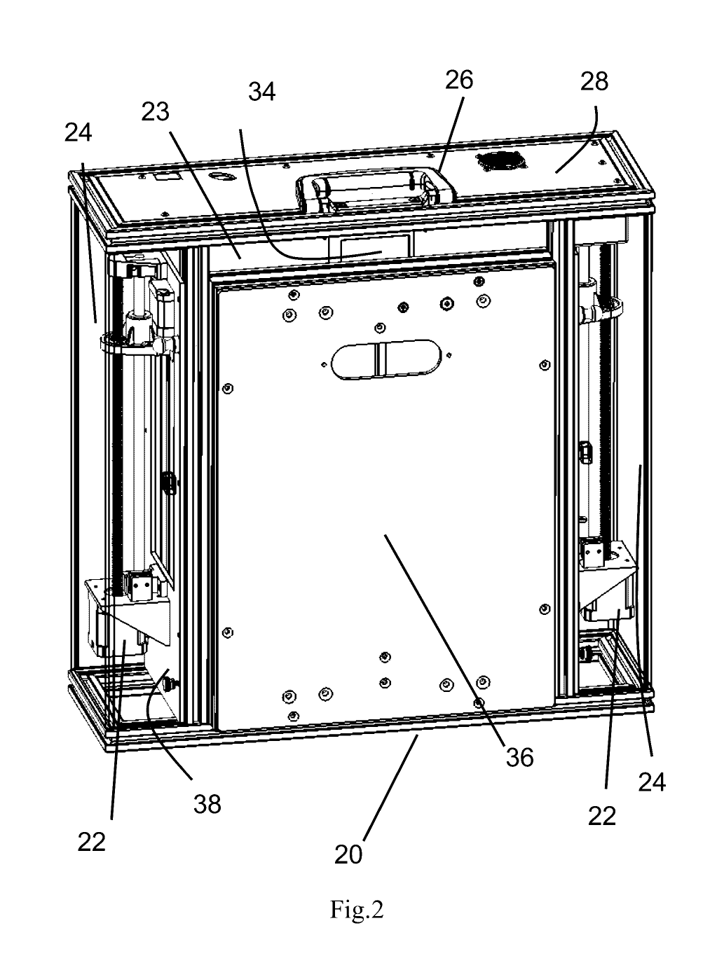

Referring now to FIGS. 1 and 2, the first embodiment of the present invention is a three-dimensional (3D) printer. The 3D printer is shown in its storage state, in which the 3D printer is not ready for printing operation but rather suitable for carrying away or storage. The 3D printer includes a frame which defines a form factor in a cuboid shape. The frame is consisted of a top plate 28, a base plate 20, and two side walls 38. On the top plate 28 there is configured a handle 26 for hand carrying of the 3D printer by a user's single hand. When the 3D printer is placed in an upright position with the top plate 28 facing upward, the top plate 28 and base plate 20 are placed in horizontal planes, while the side walls 38 are placed in vertical planes. The frame consisted of the top plate 28, the base plate 20 and the two side walls 38 therefore exhibits a “II” shape. In the space confined by the top plate 28, the base plate 20 and the two side walls 38, an object table 32 is shown to be configured in a vertical orientation. A table base 36, which is also shown to be configured in a vertical orientation, is configured adjacent and parallel to the object table 32. The object table 32 and the table base 36 together form the table assembly of the 3D printer. The table assembly is locked to the side walls 38 in the storage state of the 3D printer in FIGS. 1 and 2 which will be explained in more details later.

On the two side walls 38, there are mounted two Z-axis stepping motors 22 respectively, which are located near the base plate 20 on the side walls 38. The Z-axis stepping motors 22 are configured to drive a printer head rack 21 in the vertical direction (i.e. Z direction). On the printer head rack 21 there is mounted an X-axis stepping motor 30 which is adapted to drive the printer head 40 in the X direction. Among the two orthogonal directions in the horizontal plane in the 3D printing coordinate system, the X direction and the Y direction can be chosen arbitrarily, but for the sake of discussion here assume that in the embodiment shown in FIGS. 1-2 the X-axis is along the longitudinal direction of the printer head rack 21. The mechanism of driving the printer head rack 21 in the Z direction, or driving the printer head 40 in the X direction, involves stepping motors driving a belt which is connected to the object to be moved, and that the object is slidably mounted on one or more rails. These driving mechanism are well-known to person skilled in the art and thus their details structures are not described herein for the sake of brevity.

On the two side walls 38 there are connected two covers 24 respectively. Each cover 24 has a three-fold shape which complements the space formed by the side wall 38, and the ends of the top plate 28 and base plate 20 which extends beyond the side wall 38. Therefore, the two covers 24 make up the two faces of the cuboid shape of the form factor defined by the frame. The covers 24 are used to protect components inside the cover including the Z-axis stepping motors 22 and their corresponding belt and guiding rail mechanisms. The covers 24 are made of translucent materials so that the user may observe the components inside the covers 24. Each cover 24 is connected to a side wall 38 by two hinge joints 42. The hinge joints 42 allow a cover 24 to be rotated along a vertical axis (not shown) so that the components protected by the cover 24 may be revealed and be accessed by the user.

In the space confined by the top plate 28, the base plate 20 and the two side walls 38, there is a control unit 23 mounted right underneath the top plate 28. The control unit 23 is used to accommodate circuits essential for operation of the 3D printer, including but not limited to a PCB board, a microprocessor (MCU) as the central processor on the PCB board, on-board memory, etc. (all of these are not shown). On a front panel of the control unit 23 as shown in FIG. 2, there is a touch screen 34 for the user to monitor operation state of the printer and to access functions provided by the printer.

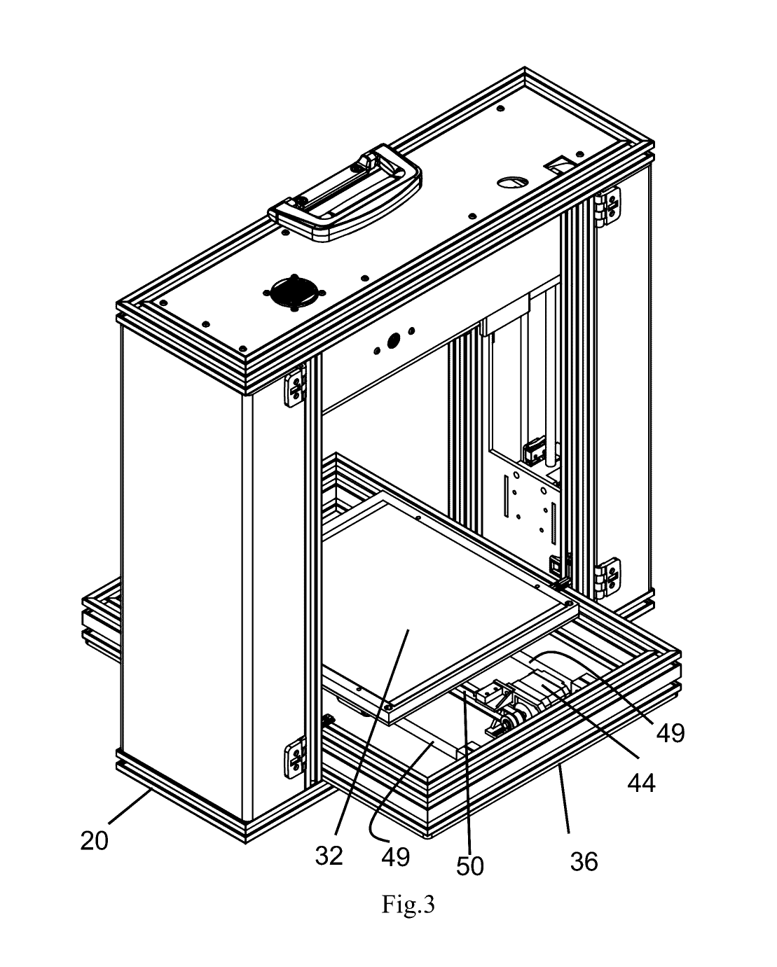

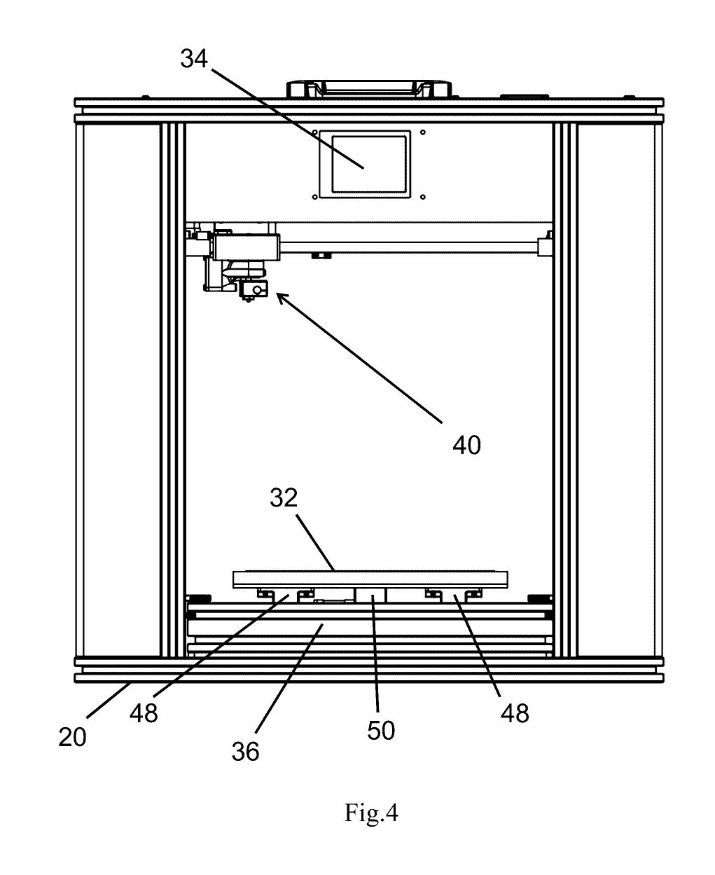

Now turning to FIGS. 3 and 4, which show the printer in FIGS. 1-2 in an operational state. The table assembly previously locked to the frame in a vertical orientation is now made horizontal so as to be parallel to the base plate 20. The table base 36 is directly supported on the base plate 20, and the object table 32 is in turn movably supported by the table base 36. One can see that in the operational state, the table assembly extends beyond the width of the base plate 20. The size of the printer defined by the area of the table base 36 and the height of the printer is much larger than that in FIGS. 1-2.

There is a Y-axis stepping motor 44 mounted in the table base 36 which is configured to drive the object table 32 in the Y direction. As clearly shown in FIG. 4, the object table 32 is slidably supported by the table base 36 by two sliding blocks 48 located on two sides of the object table 32. The sliding blocks 48, while fixed to the bottom of the object table 32, are slidably attached to the two guiding rods 49 in the table base 36. There is also a belt 50 extending near a central line (not shown) of the object table 32 which is fixed to the bottom of the object table 32. The object table 32 therefore can be driven by the belt 50 when the belt 50 is driven by the Z-axis stepping motor 44.

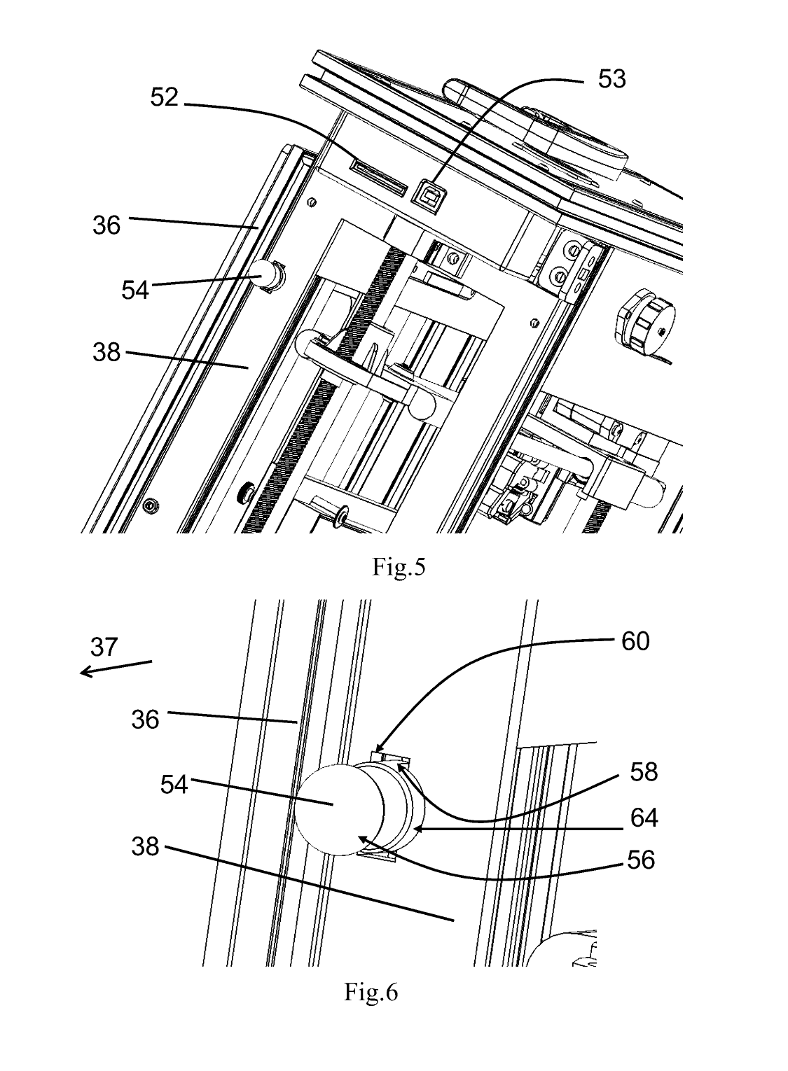

Referring to FIG. 5, in which a cover 24 of the 3D printer in FIGS. 1-4 are removed to better illustrate the components normally shielded by the cover 24. Note that the 3D printer shown in FIG. 5 is in its storage state. On a side of the control unit 23, there are a USB port 53 and a SD card reader 52 respectively. The SD card reader 52 is a type of external storage device adapter. The SD card reader 52 is connected to the central processor (not shown) of the 3D printer and is capable of read/write data stored in a SD card inserted into the SD card reader 52.The USB port 53 is also connected to the central processor and is adapted to connect to external storage devices or computing devices, like a desktop computer or a notebook computer.

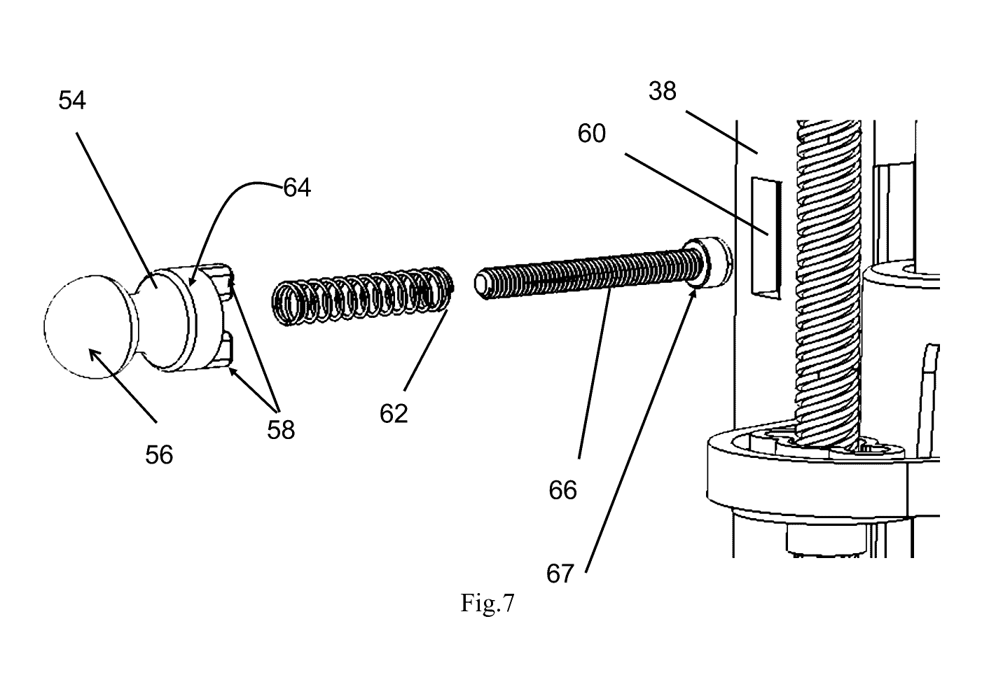

Also shown in FIG. 5 is a locking key 54 as a locking device for locking the table assembly in a storage position. In particular, when the table assembly is oriented to be upright, the table base 36 is partially received between the two side walls 38, which means that a part of the lateral side of the table base 36 overlaps with the side wall 38. Such overlapping happens on the two lateral sides of the table base 36 at the same time. Accordingly, there are two symmetrical locking keys 54 arranged on the two side walls 38 of the 3D printer. As shown in FIGS. 6-7, the locking key 54 includes a spherical part 56 and a key base 64 which are connected together and formed as an integral part. The spherical part 56 is design in such shape to allow easy picking of the locking key 54 by a user's fingers. The user can pull and/or rotate the locking key 54 by picking the spherical part 56. On an end of the key base 64 opposite to the spherical part 56, there are two protrusions 58. Also on this end of the key base 64 a locking pin 66 is fixedly secured to the locking key 54, with the tip end of the locking pin 66 located between the two protrusions 58. The locking key 54 and the locking pin 66 are connected such that they are adapted to move together along the axial direction of the locking key 54. On the other side, a spring 62 is placed between the cap end 67 of the locking pin 66 and an external face (not shown) of the side wall 38. The spring 62 provides a biasing force to the locking key 54 to fix the position of the locking key 54 when the user is not manipulating the same.

FIGS. 6 and 8 show the state of the locking key 54 which locks the table assembly to the side wall 38. On the side wall 38, there is formed a hole 60 at least a part of which has a rectangular cross-section (not shown). The locking key 54 can be partially contained within the hole 60 with the key base 64 received within the hole 60. The rectangular cross-sectional shape of the hole 60 only allows the locking key 54 to be partially received within the hole 60 when the two protrusions 58 of the locking key are exactly aligned with the rectangular hole 60. As shown in FIG. 6, the two protrusions 58 are received within the hole 60 and due to the shape of the hole 60, the locking key 54 shown in FIG. 6 cannot be rotated around its central axis, but the locking key 54 can only be pulled out along the direction indicated by Arrow 37. As shown in FIG. 8, when the protrusions 58 of the locking key 54 are received within the hole on the side wall 38, the spring 62 is in its normal, uncompressed state. As one end of the spring 62 is placed abutting the side wall 38, the cap end 67 of the locking pin 66 is kept at the location in the position shown in FIG. 8, where the locking pin 66 received within a groove formed on the lateral edge (which will be described in more details later) of the table base 36. The locking pin 66 itself passes through a through hole formed on the side wall 38. As the locking pin 66 is simultaneously received within the side wall 38 and the table base 36, the relative movement of the table base 36 and thus the table assembly from the side wall 38 in a direction perpendicular to the paper in FIG. 8 is prohibited. However, as mentioned above the locking key 54 can be pulled out along the arrow direction 37 in FIG. 6 and as a result the key base 64 is also moved to be outside of the side wall 38. The locking key 54 once pulled out should be rotated to an angle different from that shown in FIG. 6, so as to prevent the two protrusions 58 from re-entering the hole 60. Once the locking key 54 is pulled out, the locking pin 66 and its cap end 67 also move outwardly, resulting in the cap end 67 leaves the groove on the table base 36. The table assembly is then unlocked for rotation (which will be described in more details later). Also, the movement of cap end 67 as the locking key 54 is pulled forces the spring 62 to compress as the fixed end of spring 62 abuts the side wall 38 but the movable end of the spring 62 is connected to the cap end 67. The compressed spring 62 also exerts a biasing force to the cap end 67 and in turn the locking pin 66 and the locking key 54 toward the opposite direction of the arrow 37. That is to say, if the locking key 54 is pulled out but the protrusions 58 are aligned to the hole 60 then when the user releases his hand, the locking key 54 will automatically return to the positions shown in FIG. 6 due to the biasing force of the spring 62 If the table base 36 is at the same time placed in the upright direction then the automatic returning of the locking key 54 would again lock the table base 36 and thus the table assembly with the side wall 38.

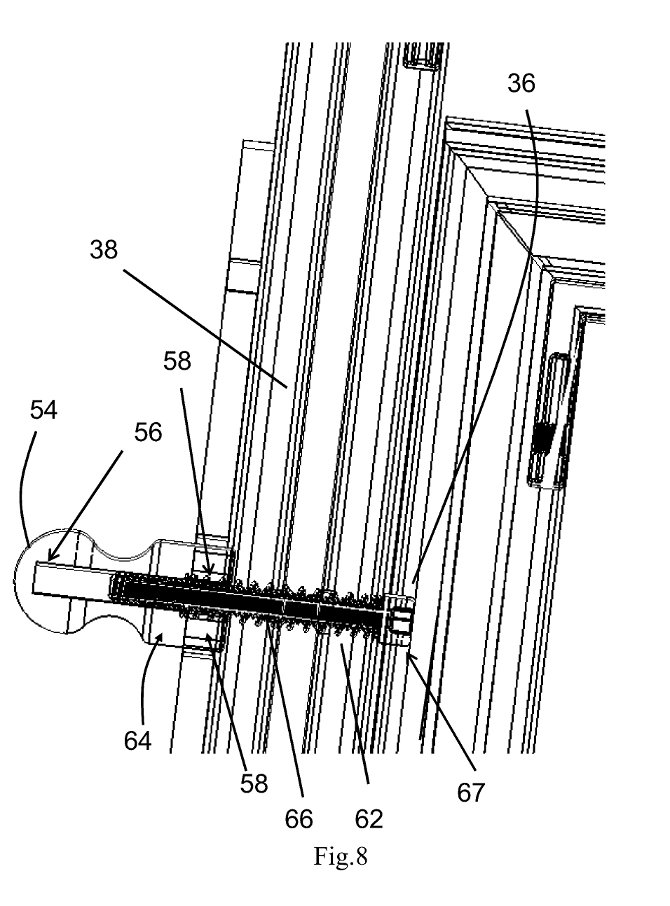

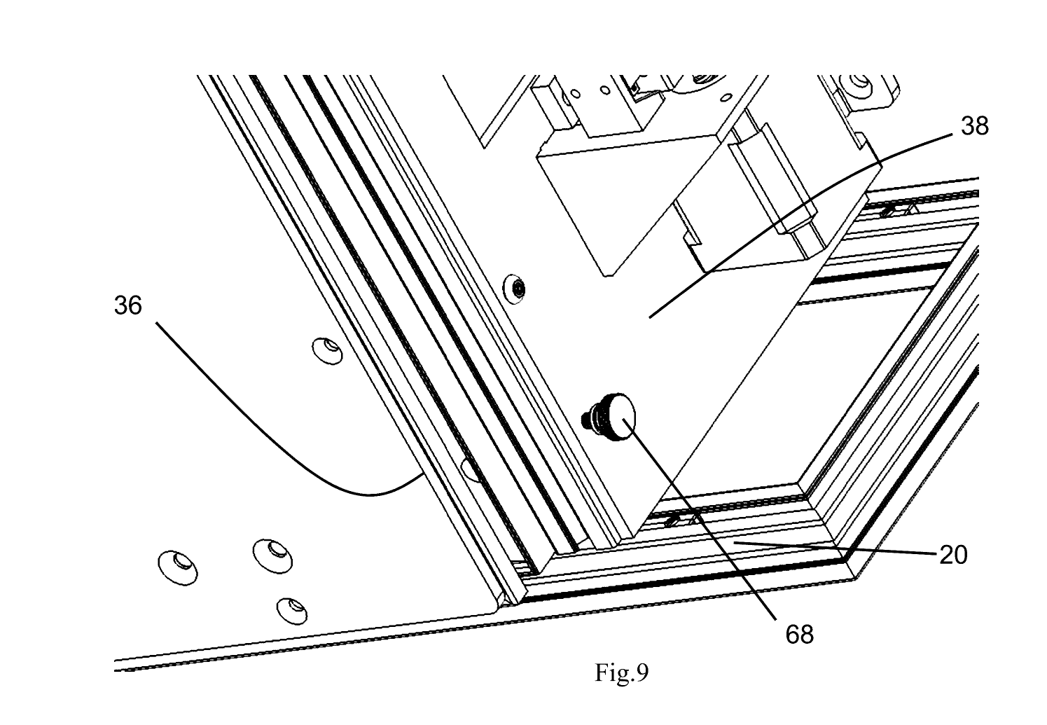

Now turning to FIG. 9, which shows another hinge key 68 located also on the side wall 38 but which is proximate to the base plate 20.The hinge key 68 functions both as a hinge for rotation of the table assembly with respect to the side wall 38 and a locking device for the table assembly. Similar to the case of the locking keys 54 in FIGS. 5-8, there are also two symmetrical hinge key 68 configured on the two side walls 38 opposite to each other.

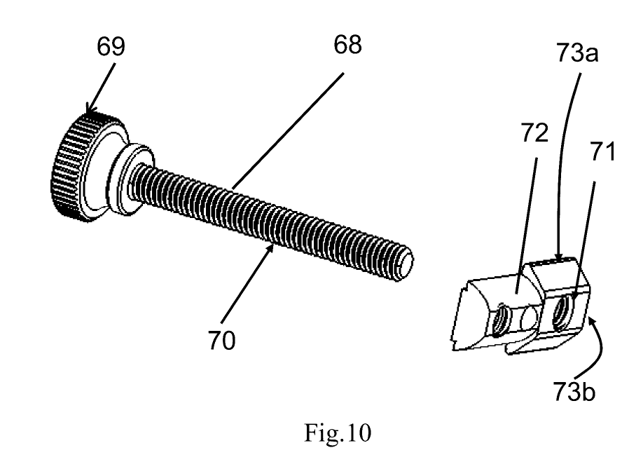

As shown in FIG. 10, the hinge key 68 contains a cap portion 69 and a screw part 70 which are connected together. The easy rotation of the hinge key 68 by a user's fingers is achieved by forming an abrasive pattern along the circumferential edge of the cap portion 69. At the end of the screw part 70 opposite the cap portion 69, there is exterior thread for engaging a stopping member 72 which is formed with a through hole 71 formed with interior thread. The screw part 70 is thread-engaged with the stopping member 72 by the engagement of the exterior thread on the screw part 70 and the interior thread in the through hole 71. The hinge key 68 and the stopping member 72 together form the hinge for the table assembly of the 3D printer. Due to the rod shape of the screw part 70, the hinge key 68 is used as the hinge pin of the hinge. The stopping member 72 is at least partially formed with a substantially trapezoidal cross-section as shown in FIG. 10. The trapezoidal cross-section is defined by a base face 73a and a top face 73b of the stopping member 72, where the top face 73b has a smaller width compared to that of the base face 73a.

Referring now to FIG. 11a. Corresponding to the hinge key 68, on the side wall 38 there is formed with a through hole which has thread (not shown) formed on its interior wall. The screw part 70 of the hinge key 68 is adapted to be thread engaged with the through hole on the side wall 38 and upon rotation of the cap portion 69, the screw part 70 moves along the thickness direction of the side wall. Note that in FIGS. 11a and 11b part of the side wall 38 is hidden for better illustrating the hinge key 68. The table assembly shown in FIG. 11a is in its storage position, i.e. the table assembly including the table base 36 is orientated upright. On the lateral sides of the table base 36, there are formed a sliding groove 78. The slide groove 78 is both for locking the table base 36 with the locking key described with reference to FIGS. 5-8, and for rotation and sliding of the table base 36 with respect to the hinge key 68. In FIG. 11a, the stopping member 72 is not received within the groove 78, which prevents sliding of the table base 36 with respect to the hinge key 68 due to the trapezoidal shape of the stopping member 72. In addition, in order to keep the table assembly 36, the hinge key 68 is rotated to be tightened, so that the end of the screw part 70 presses against the bottom of the groove 78 to lock the table base 36 from rotation. If the user would like to rotate table base 36 with respect to the hinge key 68 and hence the side wall 38, he will have to release the hinge key 68 first so that it does not extend any pressure to the bottom of groove 78 and thus unlocks the table base 36.

However, in FIG. 11b which shows the state of the hinge key 68 when the table assembly is configured in its operational position, one can see that the stopping member 72 is now received within the groove 78 of the table base 36. As the stopping member 72 is now received within the groove 78 and the stopping member 72 is aligned to be parallel to the longitudinal direction of the groove 78, the table base 36 and in turn the table assembly is able to slide with respect to the hinge key 68. However, as in the case of FIG. 11a, any relative movement of the table base 36 to the hinge key 68 and thus side wall 38 is prohibited if the hinge key 68 is tightened where the end of the screw part 70 firmly presses against the bottom of the groove 78. Therefore, if the user would like to linearly move the table base 36, he will have to release the hinge key 68 first so that it does not extend any pressure to the bottom of groove 78 and thus unlock the table base 36.

FIGS. 11a and 11b thus clearly show how the hinge key 68 together with the stopping member 72 can be used to allow rotation and sliding of the table base 36. In the state of FIG. 11a, the table base 36 is not allowed to slide with respect to the hinge key 68, but is free to rotate with respect to the hinge key 68. The user can rotate the table base 36 from the upright position shown in FIG. 11a gradually to the horizontal position in FIG. 11b. During the rotation of the table base 36, the stopping member 72 is not rotated at the same time, and it is always kept in the orientation shown in FIG. 11a. In the state shown in FIG. 11a, the stopping member 72 is not received in the groove 78, since the top face 73b (see FIG. 9) of the stopping member 72 is made perpendicular to the groove 78 and cannot be accommodated within the groove 78. During rotation of the table base 36 the top face 73b and therefore the entire stopping member 72 are always kept out of the groove 78. The table base 36 is not able to allow the stopping member 72 to slide within the groove 78 until the table base 36 is rotated to a predetermined angle, that is when the table base 36 becomes parallel to the base plate 20. Only when the table base 36 is rotated to be parallel to the base plate 20 and thus parallel to the stopping member 72, the top face 73b of the stopping member 72 can be received within groove 78. Then, the entire stopping member 72 is also received within the groove 78 and the table base 36 is able to slide relative to the hinge pin 68. As mentioned, all the rotation/sliding movement of the table base 36 is possible only when the hinge key 68 is not tightened into the groove 78 to lock the table base 36.

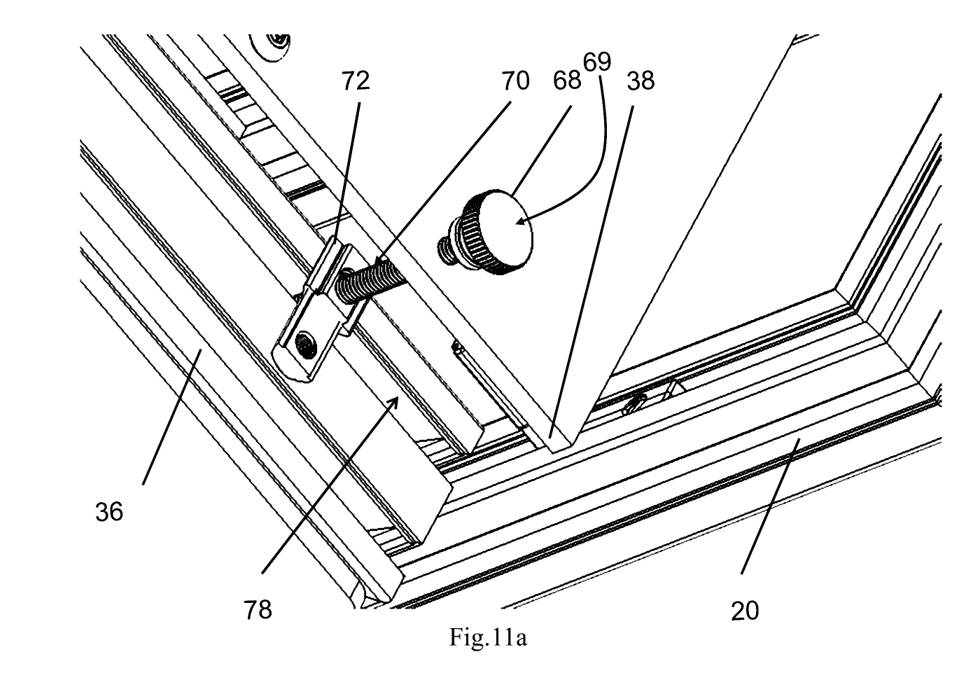

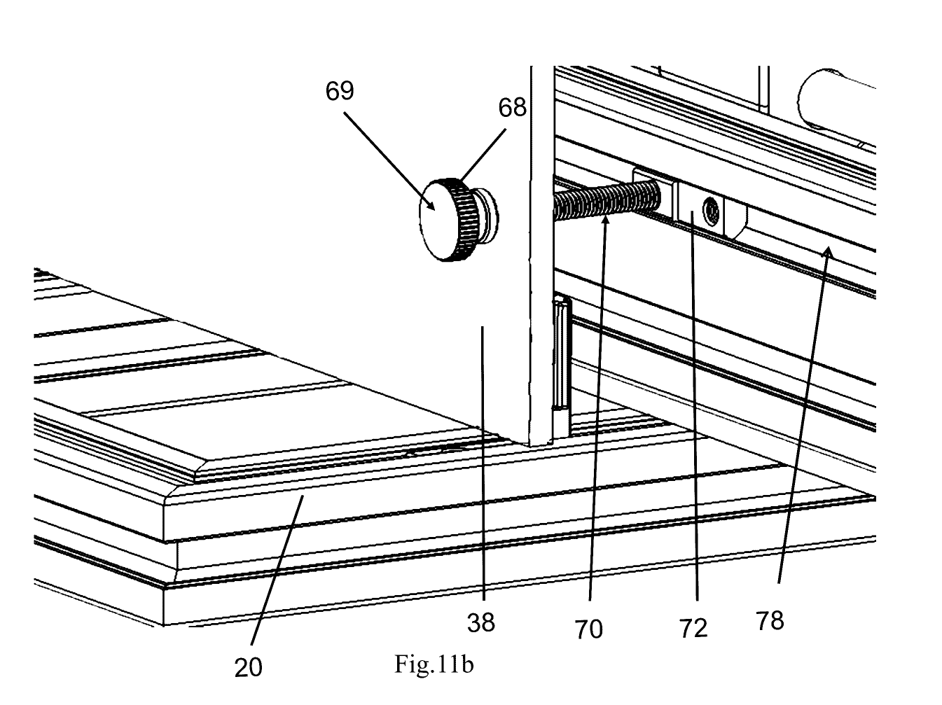

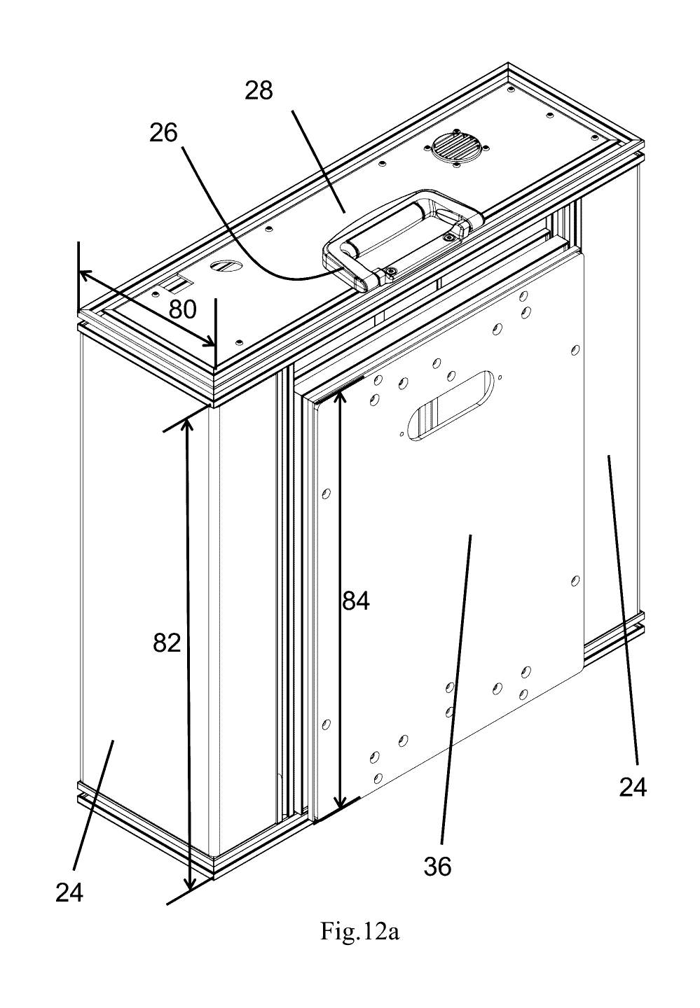

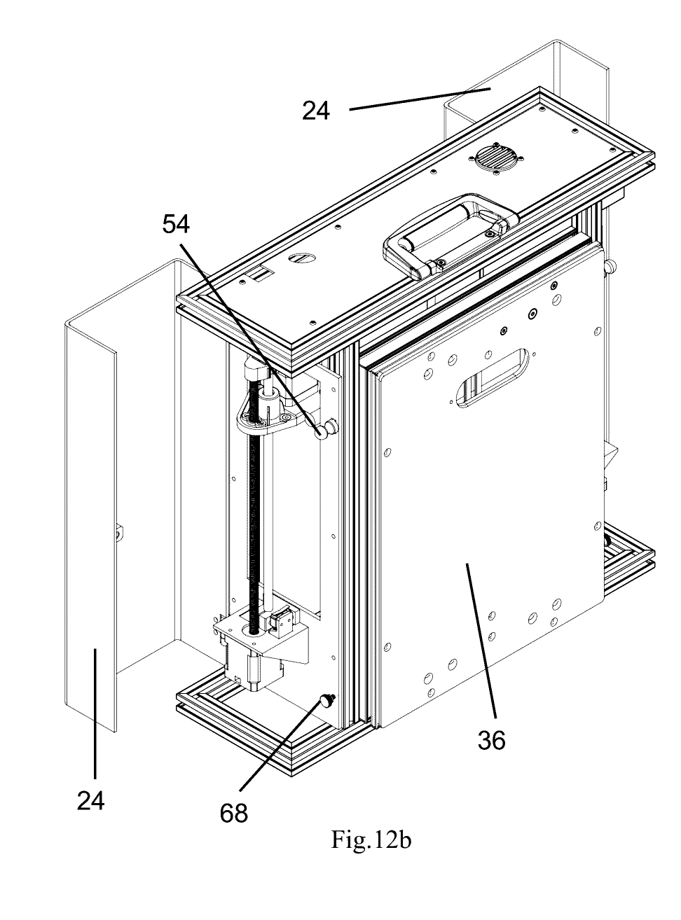

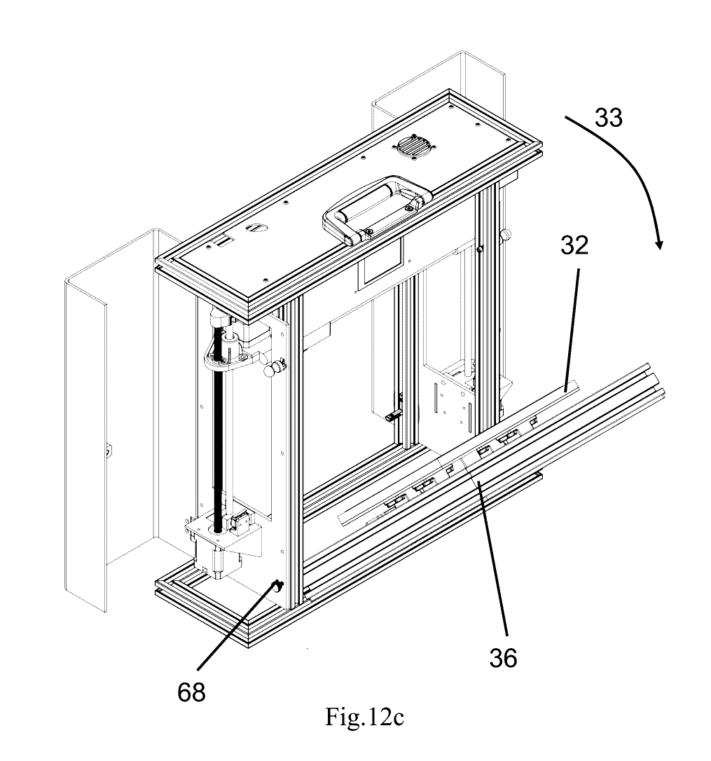

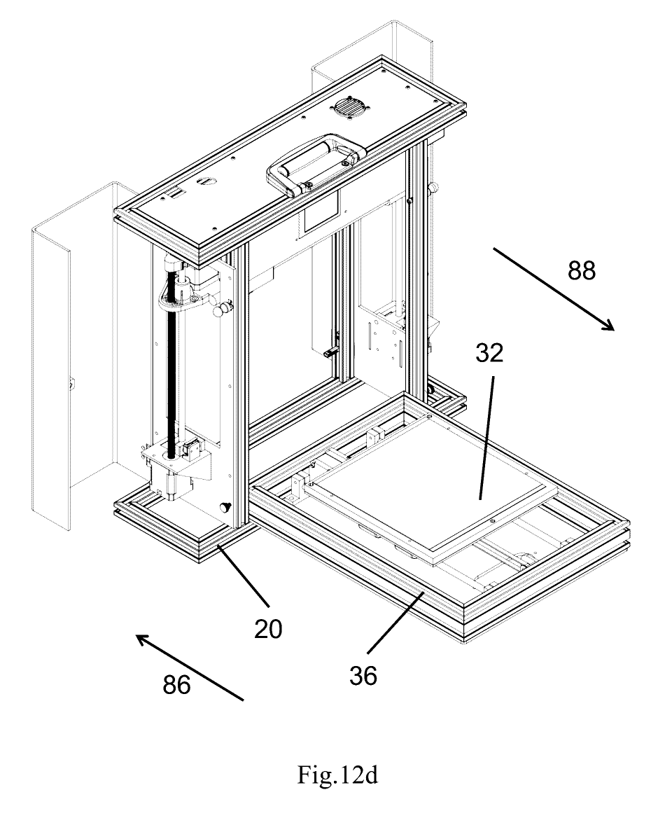

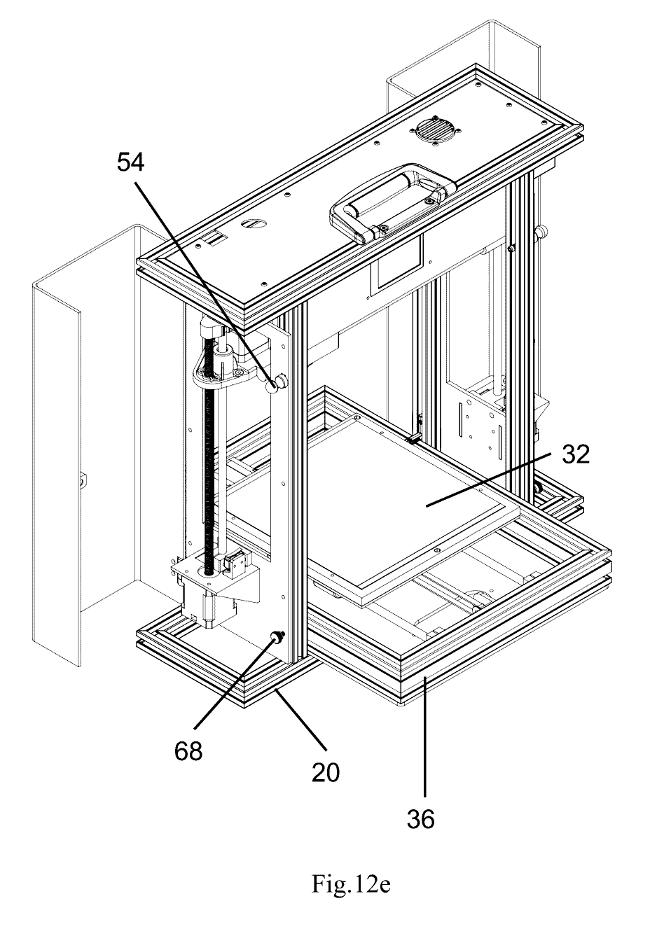

Now turning to the state changing operation of the 3D printer described above, FIGS. 12a-12f show how the 3D printer according to the present invention may be switched from a storage state to an operational state. Note that in FIGS. 12a-12f some of the features of the 3D printer are not shown for clarity reasons. The 3D printer shown in FIG. 12a, similar to that shown in FIGS. 1-2, is in the storage state. As mentioned above the 3D printer has form factor of a cuboid shape defined by the frame. By lifting up the handle 26 on the top plate 28, the user can easily carry the 3D printer wherever he goes, just like carrying a suitcase. The frame defines a first frame dimension 82 and a second frame dimension 80, which correspond to the height and width of the 3D printer in FIG. 12a respectively. The table base 36 on the other side defines a first table dimension 84 of the table assembly. As shown in FIG. 12a, the first table dimension 84 is smaller than the first frame dimension 82 and therefore the table assembly is received within the form factor formed by the two side walls (not shown), the top plate 28, and the base plate 20 of the 3D printer. That is to say, no part of the table assembly extends beyond the form factor of the frame of the 3D printer.

Next, if the user wants to change the 3D printer from the storage state to the operational state so that 3D printing can be commenced, he firstly needs to open the two covers 24 on two sides of the 3D printer as shown in FIG. 12b. Opening the covers 24 reveals the locking key 54 and hinge key 68 as described above. In order to unlock the table base 36, the user needs to pull out the locking key 54 so it no longer engages with the table base 36.The user also needs to rotate the hinge key 68 to release the hinge key 68 from pressing against the groove on the table base 36. The operation on the hinge key 68 and locking key 54 needs to be performed on both sides of the 3D printer to fully unlock the table assembly.

As shown in FIG. 12c, the user is then able to rotate the table assembly clockwise along the direction indicated by arrow 33. The table base 36 is rotated relative to the axis of rotation defined by the two hinge keys 68 until it is gradually made toward a horizontal position. The object table 32 in this process is also gradually laid down.

After the rotation in FIG. 12c is completed, the table assembly is now laid down to a horizontal position. This horizontal position is also referred to as an intermediate position since it is at a boundary position between rotational movement of the table assembly and linear movement (i.e. sliding) of the table assembly. As shown in FIG. 12d, both the table base 36 and the object table 32 are now placed in the horizontal plane, which are parallel to the base plate 20. However, the 3D printer is not ready for printing yet, as the printer head (not shown) has obviously not yet been moved into correspondence with the region of the object table 32. The next step of state change of the printer would be for the user to move the table assembly, and in particular the table base 36 to slide horizontally along the direction indicated by arrow 86. Note that as mentioned above the sliding movement of the table assembly is only possible when it is completely parallel to the base plate 20.

The table assembly is kept moving toward the center of the 3D printer until it reaches the operational position shown in FIG. 12e. In this position, the table base 36 is located at the middle of the base plate 20. As skilled persons would realize, on the lateral side of the table base 36 there can be configured certain types of stopping means to help the user determine the correct operational position of the table assembly, for example a stopping means preventing the table assemble to move further when it reaches the operational state in FIG. 12e. The user then needs to rotate the hinge key 68 to prevent the table assembly from accidentally moving during the printing operation.

Lastly, the user closes the covers 24 as shown in FIG. 12f after he locked the table assembly in the operational position by rotating the hinge key 68. The 3D printer is ready to start printing operations now. Note that in the operational state the 3D printer occupies a larger space compared to its storage state. Notably, as the table assembly is now placed in the horizontal plane, the first table dimension 84 of the table base 36 also becomes horizontal, and is parallel to the second frame dimension 80. However, the fact that the first table dimension 84 being much larger than the second frame dimension 80 makes the table assembly extending beyond the base plate 20. In other words, the table assembly extends beyond the form factor defined by the frame of the 3D printer in the operational state.

The 3D printer in FIG. 12f can then be used to print 3D objects. The three-dimensional printing is achieved by the printer head (not shown) moving in the X and Z directions, but the Y coordinates of the printer head is changed by the object table 32 moving along the Y direction. That is to say, on the object table 32, if a different point on the Y direction is to be printed, the printer head itself does not move in the Y direction, but the object table 32 moves in the Y direction so that the printer head in fact prints a point on a different Y coordinate on the object table 32.The software operation and user interaction involved in the printing operation of the 3D printer will be described in more details below with respect to other embodiments of the present invention.

Note that if a 3D printing operation is completed and the user would like to change the 3D printer from the operational state in FIG. 12f back to the storage state in FIG. 12a, what he needs to do is exactly the reverse steps of those described above with reference to FIGS. 12a-f. For example, to fold up the table assembly of the 3D printer in FIG. 12f, the user firstly needs to open the covers 24 in FIG. 12e to access the hinge keys 68. The user unlocks the hinge keys 68 so that the sliding of the table base 36 becomes possible. Then, the user moves the table base 36 allows the direction indicated by the arrow 88 in FIG. 12d. The user does not rotate the table assembly until the table base 36 reaches its end point shown in FIG. 12d. Then, the user rotates the table base 36 counterclockwise along the opposite direction of arrow 33. Once the table base 36 is rotated to its end position, which is the storage position as shown in FIG. 12b, the user then fastens the hinge key 68 to lock the table base 36 from rotation. The user also rotates the locking key 54 to make it align with the hole on the side wall of the printer and the locking key 54 automatically moves into the hole to lock the table base 36 near its upper end. Lastly, the user closes the covers 24 in FIG. 12a and the printer returns to its storage state, which is in the cuboid shape. The user is then able to carry the 3D printer or store it.

In a second embodiment of the present invention, the object table used in 3D printers is described with reference to FIGS. 13-14. As shown in the FIG. 13, the object table 132 is suitable for using in the 3D printer shown in FIGS. 1-12f. The object table 132 is adapted to be supported by a table base (not shown) similar to that described above. The object table 132 contains a table support 90, and a layer of conductive heating wire 92. On top of the heating wire layer 92 there is layer of glass 98 covered which serves to directly contact the semi-finished 3D object printed by the 3D printer. There are electrical wires 94 which extend out of the table support 90 for connecting to external power sources. The electrical wires 94 are electrically connected to the heating wires in the heating wire layer 92 for supplying electrical current to the heating wires. There are also signal wires 96 used to connect thermal sensors (not shown) which are coupled to the heating wire layer 92 to external controllers, for example the central processor in the 3D printer. The thermals sensors detect real-time temperature of the heating wire layer 92 and feedback it to the controller, so that the controller may adjust current supplied to the heating wires to make it at a predetermined temperature.

As shown more clearly in FIG. 14, the heating wire layer 92 is not directly placed on top of the table support 90. Rather, underneath the heating wire layer 92 there is a thin film layer 100 which is made of polyimide. Although not shown, there is another polyimide film (not shown) placed directly on top of the heating wire layer 92. The heating wires in layer 92 are made of metal, for example Fe—Cr alloy. The heating wire layer 92 is therefore sandwiched by the two polyimide films and which as a whole are placed between the glass 98 and the table support 90. The glass 98 is borosilicate glass which has a thickness of around 3 mm. The glass 98 provides an exactly flat surface of the object table for supporting the 3D object, and the flatness does not change because of any drastic temperature change. The borosilicate glass is therefore a non-deformable material. This is much more desired compared to traditional 3D printers which use metal surfaces for the object table like aluminum, which is vulnerable to deformation due to temperature change, and leading to misallocation of the 3D object on the object table.

The object table 132 described above is suitable for a 3D printer using fused filament as the printing material. As there is a heating wire layer 92 in the object table 132 which is also temperature controlled, the object table 132 can provide desired temperature on the surface of the glass 98. The polyimide film is known to be suitable for heat conduction and so the heat generated by the heating wire layer 92 is efficiently transmitted to the surface of the glass 98. The temperature is important to the semi-finished 3D object since a proper temperature would keep the object (not shown) in the fixed position on the object table 132. If the object table 132 is not warmed up then there will be no adhesive effect produced on the 3D object which makes it very easy to slide on the glass 98. The misallocation of the semi-finished product is fatal to the 3D printing as the printer cannot continue printing on the 3D object with incorrect coordinates. The temperature on the object table 132 can be adjusted in a predetermined range depending on the environment temperature of the place where the 3D printer is placed. For example, the object table temperature can be adjusted between 50-60 Celsius degrees.

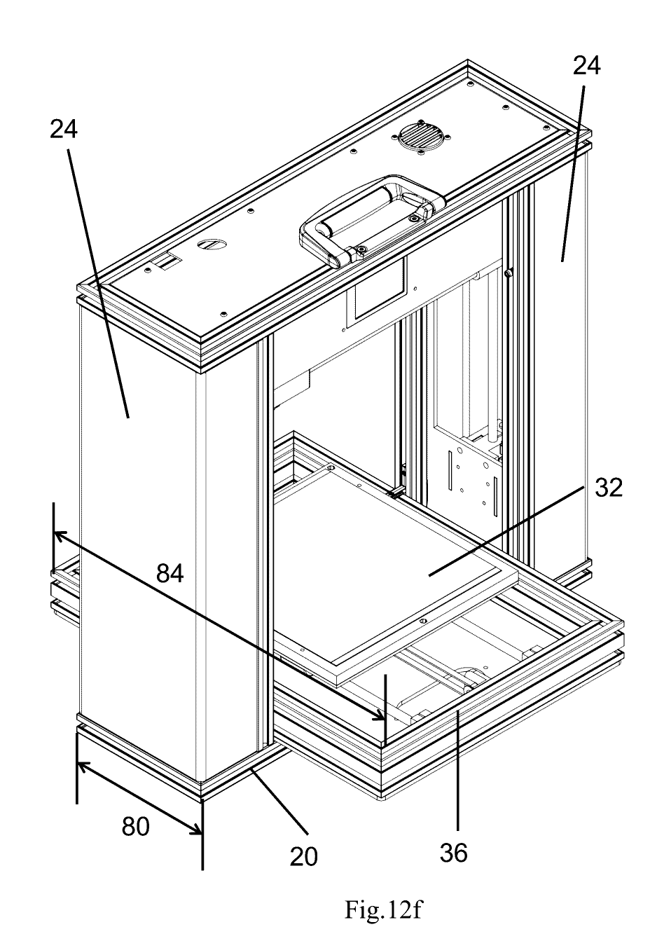

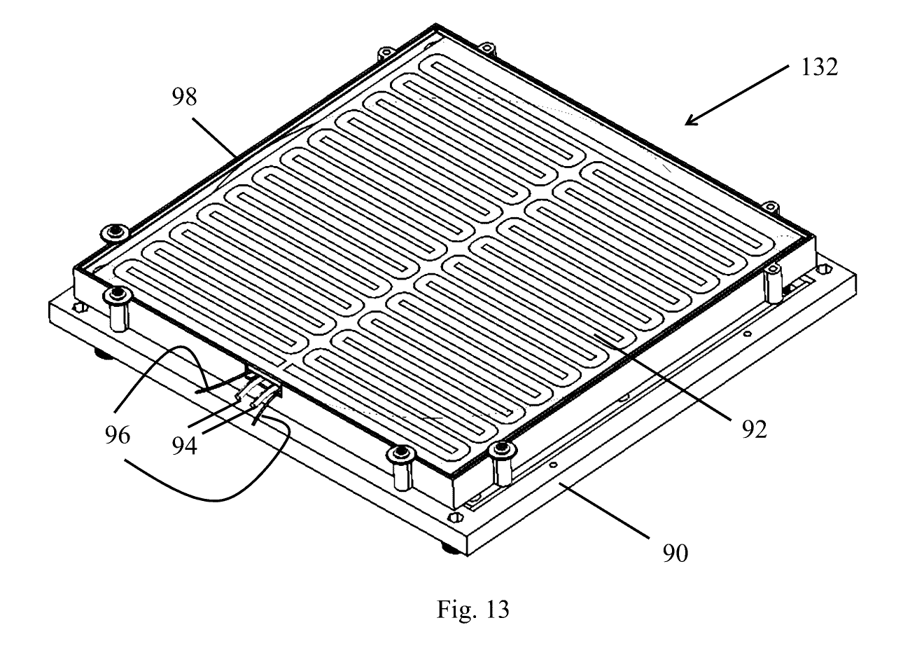

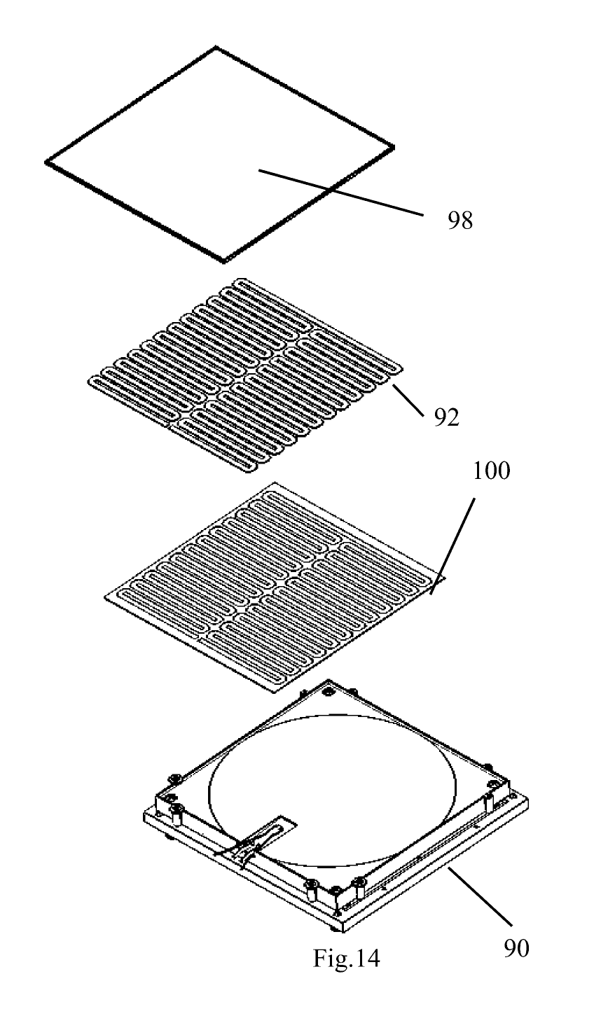

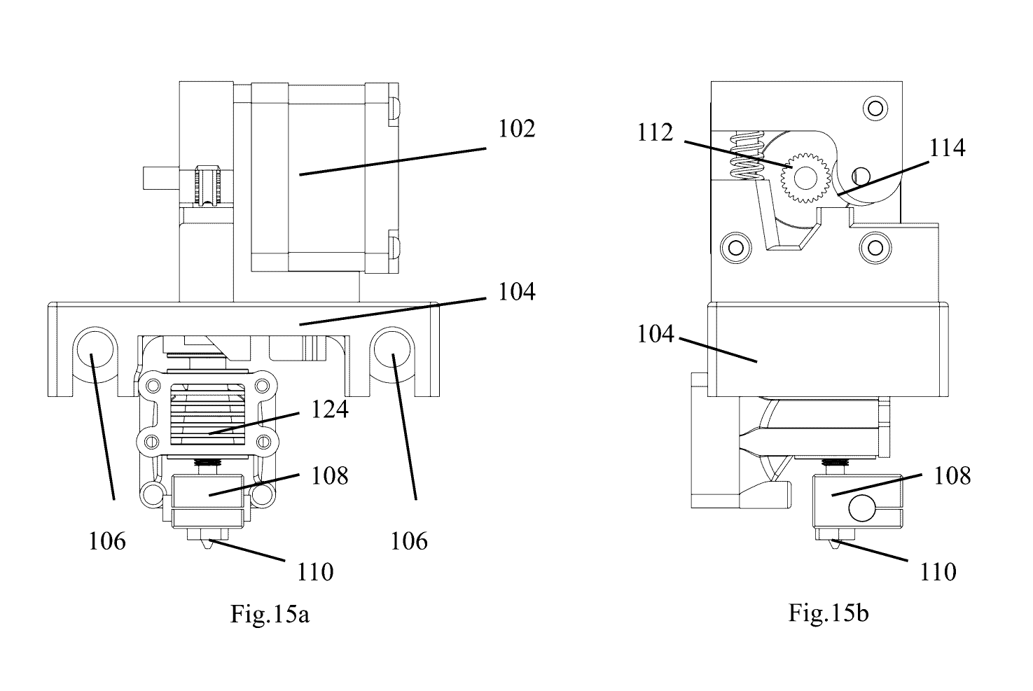

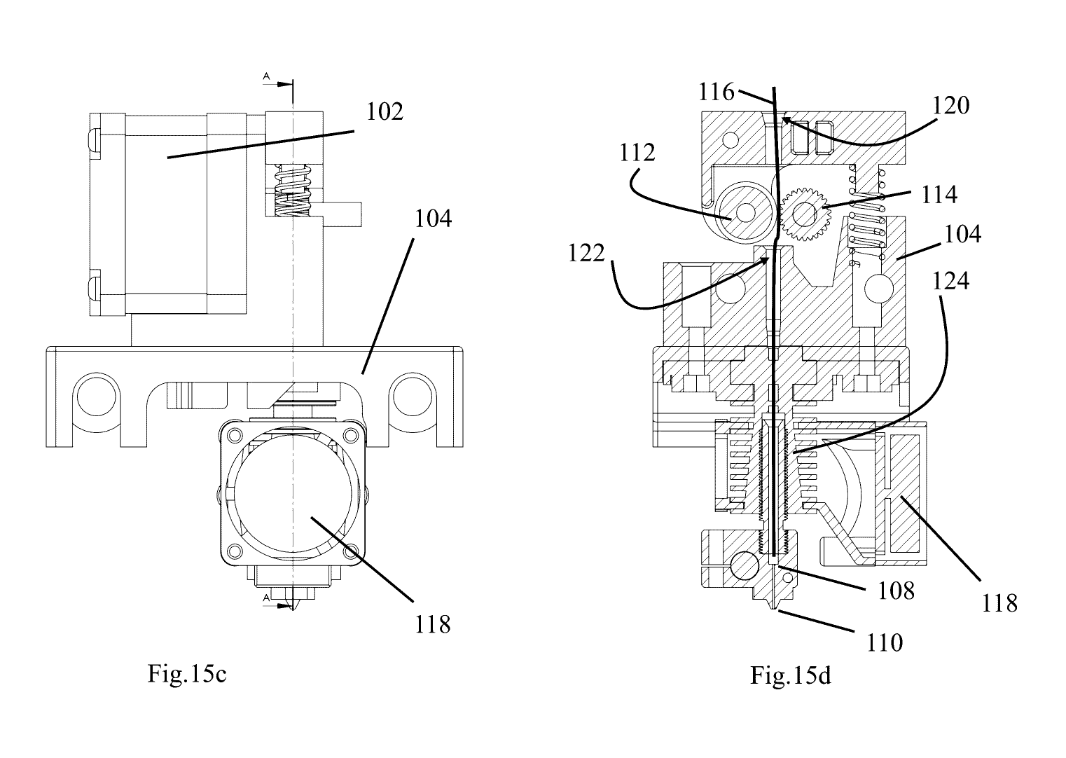

In a third embodiment of the present invention, the printer head used in 3D printers is described with reference to FIGS. 15a-15d. The printer head contains a filament feeding device integrated with the printer head which serves to supply filament into the heating chamber of the printer head to melt the filaments. As shown in FIGS. 15a-15b, the printer head includes a head support 104 which is slidably mounted on two guiding rods 106 which are connected to the frame of the 3D printer (not shown). By suitable driving mechanism such as a stepping motor and a belt, the printer head can be controlled to move along a certain direction as described above. All the other components of the printer head are connected to the head support 104. For example, the feeding device contains a stepping motor 102 which is mounted on the head support 104. The stepping motor 102 is connected to a gear 112 to drive the latter. Opposite to the gear 112 there is an idle wheel 114 which is freely rotatable. Under the head support 104 there are a number of components including a heat sink 124, a heating chamber 108 connected to the heat sink 124, and a nozzle 110 at the bottom of the heating chamber 108. The nozzle 110 is in fluid communication with the heating chamber 108. Also installed under the head support 104 is a fan 118 which is configured to directly face the heat sink 124. The heat sink 124 is a type of passive cooling device as skilled person would understand, and the fan 118 is a type of active cooling device. The heat sink 124 has a substantially cylindrical shape and multiple fins are arranged along the central axis of heat sink 124.

The filament fusion and printing mechanism is illustrated in FIG. 15d. The fusible filament 116 is inserted from a first slot 120 on the head support into the printer head. The filament 116 is aligned to be placed between the gear 112 and the idle wheel 114. When the output shaft of the stepping motor 102 rotates, the gear 112 also rotates and forces the filament 116 to move which the filament 116 contacts the gear 112 and be clamped between the gear 112 and the idle wheel 114. The filament 116 continues to move downward in FIG. 15d until it enters a second slot 122 which leads all the way through the heat sink 124 and to the heating chamber 108. The filament 116 is melted inside the heating chamber 108 as the heating chamber 108 is heated by electrical heaters controller by the controller of the 3D printer, as a skilled person would understand. The melted filament is then outputted through the nozzle 110 to form the 3D object. The heating chamber has a very high temperature which is required to quickly melt the incoming filament. However, the filament 116 before entering the heating chamber 108 should not be subject to high temperature in order to avoid interruption to the printing operation. For this purpose, both the fan 118 and the heat sink 124 are used to cool down the temperature of the filament 116 before it enters the heating chamber 108. The combination of the heat sink 124 and the fan 118 provides a very effective cooling effect which allows the heat conducted from the heating chamber 108 to dissipate quickly. Ideally, the fan 118 will automatically be turned on by the controller in the 3D printer if it is detected that the temperature of the heat sink 124 is above 50 Celsius degrees.

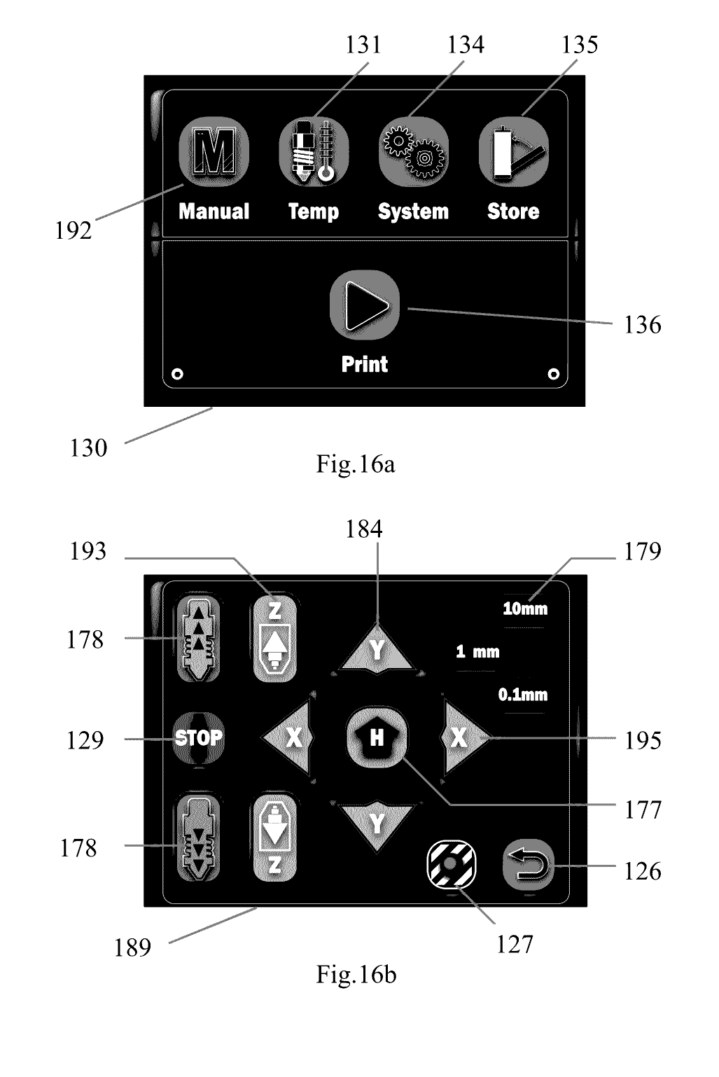

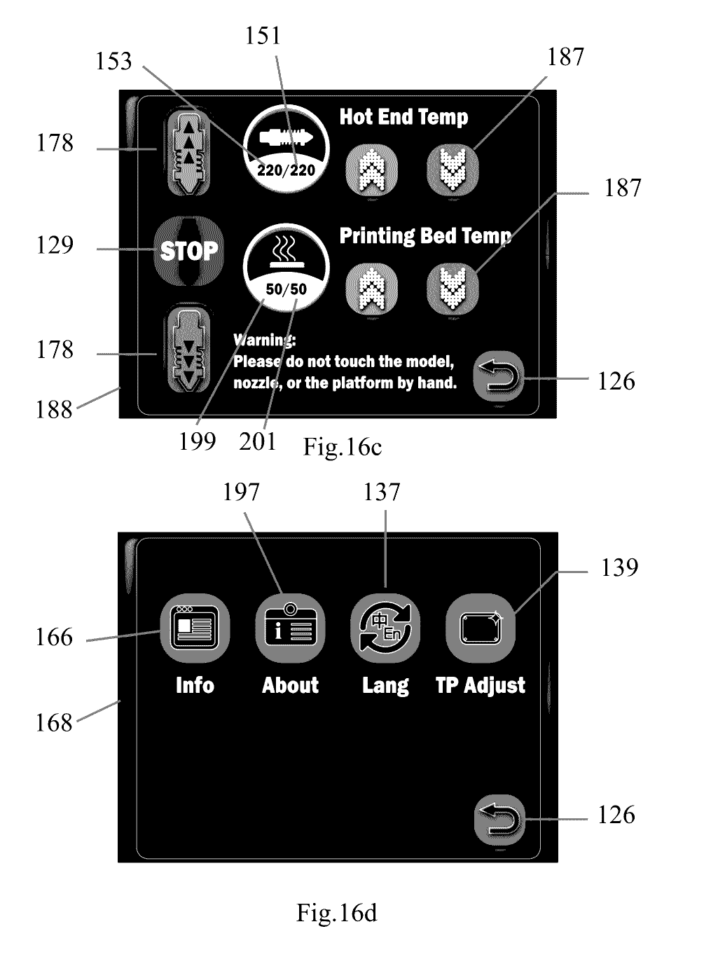

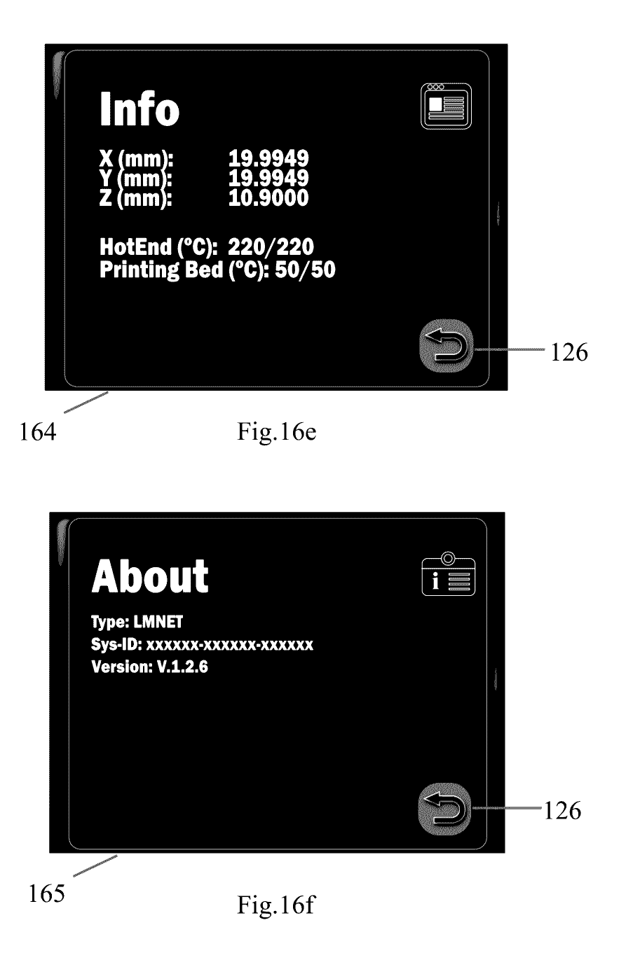

In a fourth embodiment of the present invention, the user interface provided on a touch screen of the 3D printer such as the one shown in FIG. 1 is described. As the printer provides a touch screen, all the user input and instructions can be made via the touch screen. In FIG. 16a, a main screen 130 is shown on the touch screen once the 3D printer is powered on and ready for use. The “System” icon 134, once pressed, will lead to the system screen 168 in FIG. 16d. The “Temp” icon 131, once pressed, will lead to the temperature control screen 188 in FIG. 16c. The “Manual” icon 192 allows the user to manually control the X, Y and Z positions of the printer head. The “Store” icon 135 allows the printer head to move to the parking location (which will be described in more detail later). The main icon in the main screen 130 is the “print” icon 136, which allows the user to start the printing operation.

Once the user presses the “Manual” icon 192 in screen 130, the head adjusting screen 189 will show as illustrated in FIG. 16b. There are six icons for controlling the Z, X and Y positions of the printer head. In particular, two “Y” icons 184 are provided for the user to manually adjust the location of the printer head on the Y axis. Similarly, “X” icons 195 and “Z” icons 193 are provided for the user to manually adjust the location of the printer head on the X axis and Z axis respectively. The X, Y and Z positions are adjusted by sending commands to respective stepping motors for each of the axes by the controller, as will be appreciated by skilled persons in the art. The screen 189 further provides control of the step length of each movement of the printer head on the X, Y or Z directions. In particular, three step length icons 179 are provided for the user to select that for each step of the movement (that is, when the user press the icons 184, 193 or 195 once), whether the printer head moves for 1 mm, 0.1 mm or 10 mm in the direction selected. If the user presses on the “home” icon 177, then the printer head returns to a default or home position in the printing region, for example the position with a (0, 0, 0) coordinate.

In the screen 189, there are further provided buttons for controlling filament feeding operation. In particular, “feeding control” icons 178 are for the user to manually control feeding of filament into the printer head, e.g. loading and unloading the filament by action of the stepping motor configured to drive the feeding mechanism as described above. The icons 178 are designed that once the user presses it, then without the need of the user to keep touching the screen, the loading or unloading automatically continues. As a result, a “stop” icon 129 is provided to the user for stopping the continuous loading or unloading of filament. In the screen 189, there is also provided a “return” icon 126 which allows the user interface to shift back to the previous screen. An “emergency icon” 127 is provided to user for stopping the operation of the printer at any time immediately.

On the other hand, if the user presses the “Temp” icon 131 in the main screen 130, it will leads to a temperature control interface 188 illustrated in FIG. 16c which shows real-time temperature 199 of the object table and real-time temperature 153 of the printer head. The target temperature 201 of the object table and the target temperature 151 are also shown. Accompanying the temperature readings, adjusting icons 187 are provided so that the user can manually adjust these temperatures if necessary by using the icons 187. In the screen 188, there are also provided a “return” icon 126 which allows the user interface to shift back to the previous screen. Similar to screen 189, in screen 188 icons 178, 129 for controlling filament feeding operation are again provided for the user's easy operation.

FIG. 16d shows the system screen 168 after the user presses the “system” icon 134 in the main screen. There are different functions in the system menu in the system screen 168 which include displaying information of the printer. The information of the printer is accessed by pressing on the “info” icon 166 and then an “Info” screen 164 shows up as illustrated in FIG. 16e, which displays current information of the printer including the head position (in X, Y and Z coordinates) of the printer head. If the user presses the “About” icon 197 in screen 168, then the a “About” screen 165 shows up as illustrated in FIG. 16f, which display information such as the serial number of the printer, its firmware version number, and the name of the printer. Note that in both “About” screen 165 and “Info” screen 164 there are provided a “return” icon 126 to return the user interface back to the previous screen. In addition, “language” icon 137 is used to switch the texts in the user interface between languages such as between the Chinese language and the English language. The “TP Adjust” button 139 is used to adjust the display screen to a correct position.

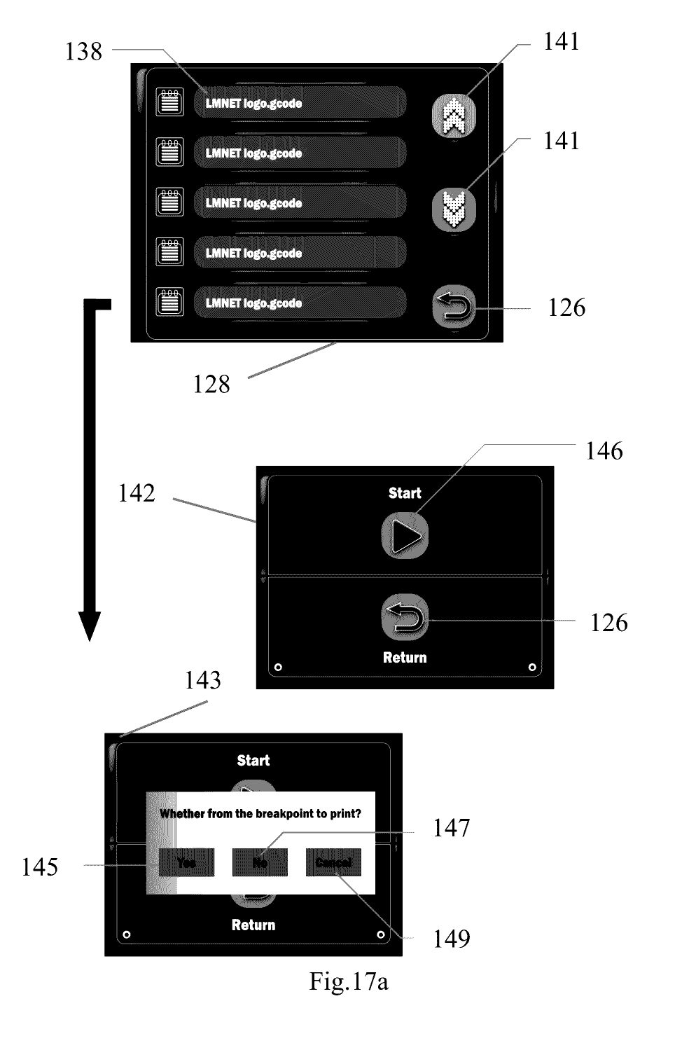

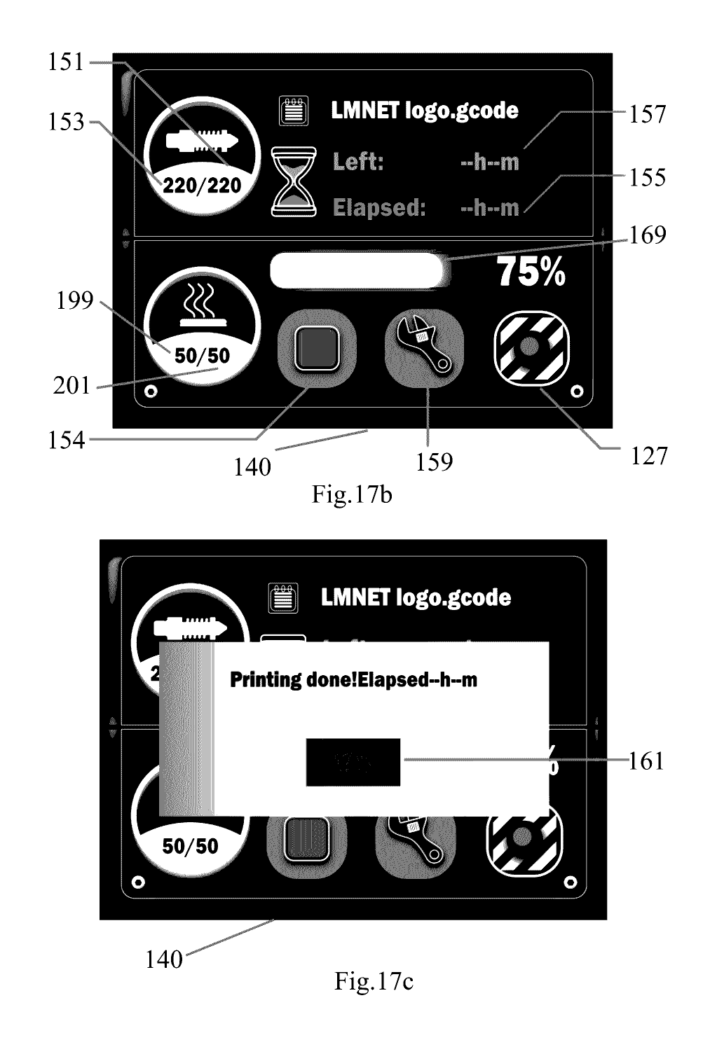

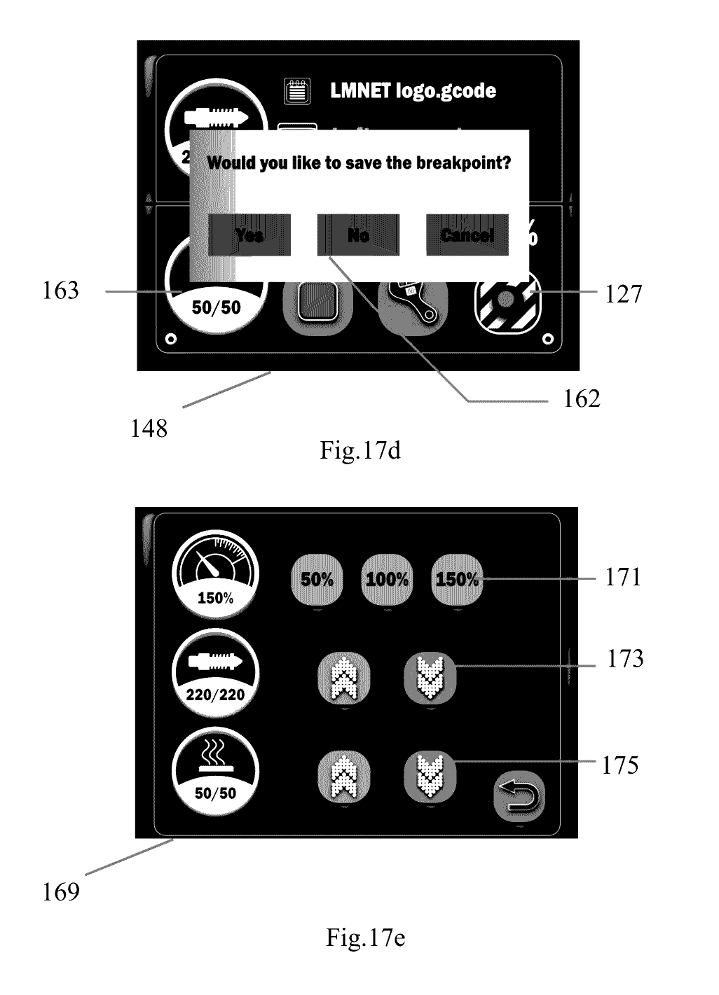

Turning now to FIGS. 17a-17e, once the user presses on the “print” icon 136 in the main screen 130, the display goes to the file selection screen 128. Here, a list of available 3D model files 138 to be printed is shown. The list may contain more items than can be displayed in one screen so scrolling icons 141 are provided to scroll up/down the file list. The displayed 3D model files 138 may be stored in the internal memory of the 3D printer or external storage devices like an SD card which is connected to the 3D printer. Or, the 3D model files 138 can be remote files saved on an external computer which is connected to the 3D printer via for example by a USB connection or via Wi-Fi. The user can presses on the specific file in file selection screen 128, where a file operation window 142 for this file will appear. The user can press the “print now” icon 146 to start printing immediately. There is also provided a “return” icon 126 which allows the user interface to shift back to the previous screen.

After the “print now” icon 146 is pressed in screen 142 for a particular file, the printer controller will determine whether there is any breakpoint stored in the memory of the printer (which will be described in more details below). If there is indeed a stored breakpoint, a dialogue box 143 appears which prompts the user to choose whether he would like to continue printing of a previous unfinished job (i.e. the break point), or he wants to start a brand new printing. In the dialogue box, “Yes” icon 145 is pressed if the user wants to resume a breakpoint printing. “No” icon 147 is pressed if the user wants to start a brand new printing. If the user presses “Cancel” icon 149, then no printing job will commence and the display goes back to the previous screen.

If the user presses “Yes” icon 145 or “No” icon 147 above, then the printing progress screen 140 as illustrated in FIG. 17b will appear, which shows parameters such as the progress bar of printing, the temperature of the object table, the temperature of the printer head, etc. In particular, screen 140 shows real-time temperature 199 of the object table and real-time temperature 153 of the printer head. The target temperature 201 of the object table and the target temperature 151 are also shown. Other information such as the elapsed printing time 155 and remaining time to go 157, as well as the progress 169 of the printing job represented by a progress bar and a percentage are also displayed. There are also three buttons shown in the printing progress screen 140. During the printing progress, if the “stop” button 154 in the printing progress screen 140 is pressed, the user is prompted to make a selection as whether he would like to store the in-progress printing as a breakpoint and resume the printing later in the “save job” window 162 (shown in FIG. 17d). The work flow of the breakpoint resuming for the printing operation will be described in details later. The emergency icon 127 is provided for the user to immediately stop the printer's operation.

Pressing the “Tool” icon 159 in screen 140 will show a tool window 169 as shown in FIG. 17e, which provides in-work adjustment of the printer such as printing speed icons 171 for controlling the speed of printing in one of the half speed, full speed, and 150% speed modes. Icons 173 and 175 are provided for controlling the temperatures of the printer head and the object table respectively, similar to that in screen 188 described above.

If the printing job eventually finishes, a pop-up window 161 as illustrated in FIG. 17c will appear in the printing progress screen 140 which tells the user what is the total elapsed time for the printing.

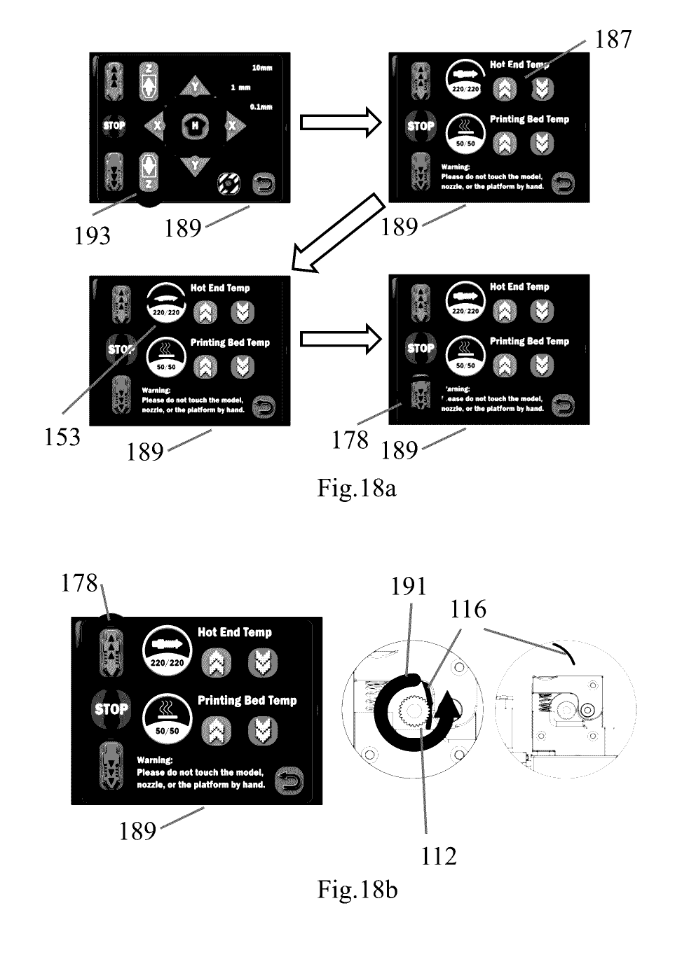

FIG. 18a shows the user interface and steps of loading filament into the printer. The user needs to enter the head adjusting screen 189 to perform filament loading. As a first step, the user presses “Z” icon 193 in screen 189 to lower the printer head. Then, the user presses temperature adjusting icon 187 to increase the temperature of the printer head, until the displayed printer head temperature 153 reaches 220 Celsius degrees. Finally, as the temperature of the printer head is now ready for printing the filament (not shown) can be placed with its end in the feeding device and the user presses loading/unloading icon 178 to load the filament.

On the other side, if the printing of a 3D object is finished, but there is remaining filament in the printer head, the user needs to unload the unused filament to avoid congestion of the filament after it is cooled down. This is shown in FIG. 18b where unloading of the filament must also be made when the printer head is at the working temperature, i.e. 220 Celsius degrees. The user presses the loading/unloading icon 178 to eject the filament from the printer head. In this process the stepping motor (not shown) of the filament feeding device drives the gear 112 in the counterclockwise direction to unload the filament 116 until it finally leaves the printer head.

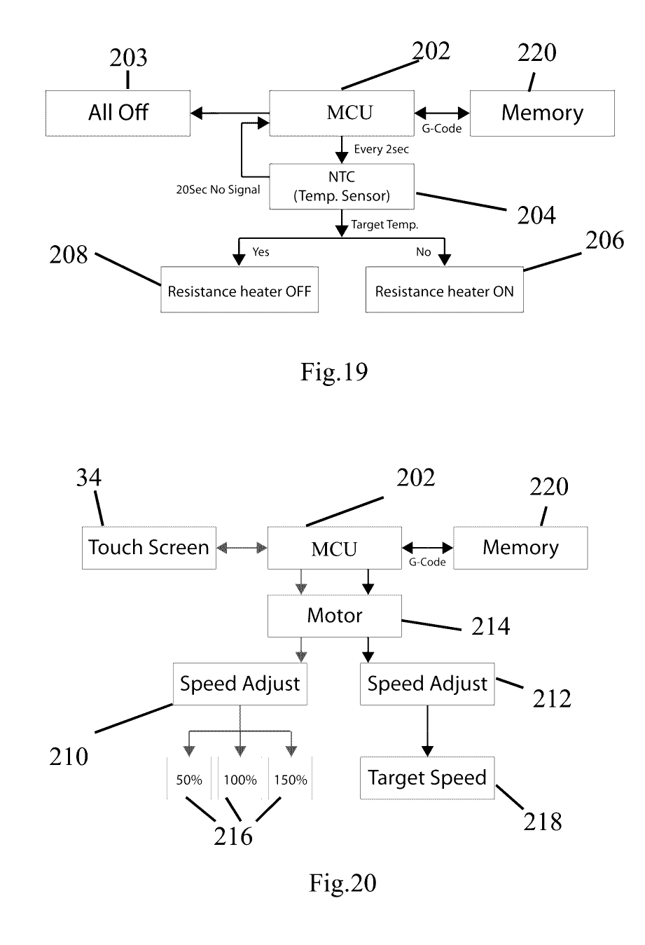

In a fifth embodiment of the present invention, various control principles and work flows of the 3D printer are described. In FIG. 19, a temperature control process used for controlling the temperature of the object table/printer head is shown. As mentioned above the printer head and the object table may both contain resistance heaters for heating. The microprocessor (MCU) 202, being the central processor of the 3D printer, is connected to the non-transitory computer readable memory 220 of the 3D printer. Program code containing instructions for operating the printer are stored in the memory 220. For temperature control, the MCU 202 queries a temperature sensor 204 which is placed on or adjacent the component which the resistance heater is heating, for example the object table or the heating chamber in the printer head. The MCU 202 enquires the temperature sensor in Step 204 on a regular basis, for example every 2 seconds. Depending on the readings of the temperature sensor, the MCU 202 determines whether the target temperature is reached. If no, then in Step 206 the heater is turned on or maintained in the “on” state to continuously heat the component. However, if the MCU 202 determine that the target temperature is reached, then in Step 208 the heater will be turned off to prevent further temperature rising. However, in the unusual case where no response from the temperature sensor is received by the MCU 202 after a predetermined period of time, say 20 seconds, then the MCU 202 determines that the temperature sensor is malfunctioned. The MCU then controls all components of the 3D printer to stop working (e.g. heating, motor rotation, etc.) in Step 203 to present any possible damages to the system components due to overheating.

FIG. 20 shows the motor speed control flow of the various stepping motors in the 3D printer. The stepping motors, as described above, may include one or more of the X, Y, Z axis stepping motors, and the stepping motor for filament feeding which is located in the printer head. As described above, the microprocessor (MCU) 202, being the central processor of the 3D printer, is connected to the memory 220 of the 3D printer. Program code containing instructions for operating the printer are stored in the memory 220. The MCU 202 is connected to the touch screen 34 to display operation information of the 3D printer to the user or to receive user inputs via the touch screen 34. The MCU 202 controls the motor speed of a particular stepping motor 214 either based on predefined control criteria as those stored in the program code, or based on user input. Depending on the instructions received from the MCU 202, the motor 214 can have speed adjustment in different ways. For example, if the speed adjustment is in line with predefined speed levels in Step 210, then the motor can be set to run at one of the three speeds modes in Step 216, i.e. a 50% speed mode, a 100% speed mode, and a 150% speed mode. Alternatively, the motor 214 may be controlled to run at a particular speed in Step 212. Under this speed control mode the motor will be controlled to reach the target speed in Step 218 for example through a feedback control mechanism.

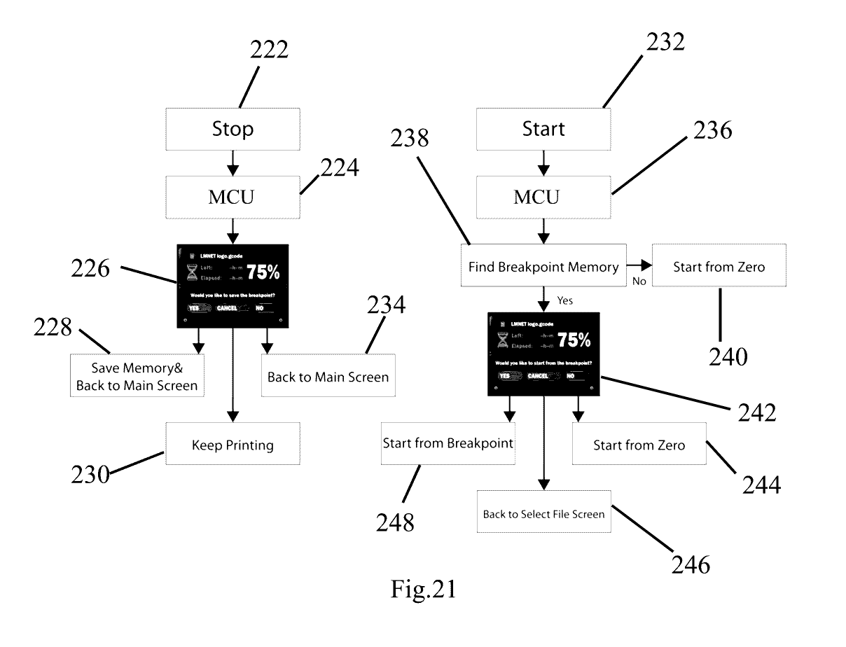

FIG. 21 shows the breakpoint printing work flow of the 3D printer according to an embodiment of the present invention. The breakpoint printing, as described above, means that an in-progress printing can be interrupted and saved in the memory of the printer. The printer can then be powered off. When the printer is powered on again, the user may choose to reload the breakpoint at which the previous unfinished printing stopped. Then, the printer can continue to perform the unfinished printing. The processes of saving an unfinished work and resuming from a saved work are illustrated in FIG. 21. During the normal printing process of the 3D printer, if the user presses a “stop” button (for example the screen button 154 in FIG. 17b) in Step 222, the MCU acknowledges this instruction in Step 224 and shows a dialogue box in the screen in Step 226 to ask the user whether he would like to terminate the printing, save the unfinished printing to the memory, or if the user does not want to do anything. If the user presses “cancel” in Step 226, then printing operation continues in Step 230. If the user presses “No” in Step 226, then printing operation will be canceled, and the user interface goes back to the main screen in Step 234 to wait for further instructions from the user. If the user presses “Yes” in Step 226, then printing operation will be stopped, but the current information of printing will be saved as a breakpoint into the memory of the printer. Such information including parameters of various components like the temperature of the printing head and the object table, the speed of the various stepping motor, and the last X, Y, Z coordinates of the printer head. The user may then turn off the power of the printer since the breakpoint saved in the printer memory will not be lost even if the power is off. Optionally, before the printer is powered off, there may be a printer head parking procedure, which may either be initiated by the user or automatically performed by the printer itself. The printer head parking function returns the printer head to a parking location to better protect the printer head, similar to that in a hard disk drive.

When the printer is powered on again after any period of time in Step 232, the MCU will perform necessary self-test and calibration steps in Step 236. Then, the MCU looks for the breakpoint in memory to see if there is any saved and unfinished printing job in the memory. If no, then the printer will goes to the main screen as in normal start-up cases in Step 240. However, if the MCU found a breakpoint in the memory, a dialogue box will pop-up in Step 242 to ask the user if he wants to resume the previous stopped printing job, start a new printing job, or if he does not want to do anything. If the user presses “cancel” in Step 242, then the printer goes back to the main screen and awaits further instructions from the user. If the user presses “No” in Step 242, then the printer will not resume the previous saved print job but starts a new printing job in Step 244 for example by prompting the user to select a 3D model file to print. If the user presses “Yes” in Step 242, then the previous unfinished printing will be resumed in Step 248. In doing so the MCU reads information from the memory which includes parameters of various components like the temperature of the printing head and the object table, the speed of the various stepping motor, and the last X, Y, Z coordinates of the printer head. As soon as all the necessary conditions are met like the printer head reaches the last saved position and the predefined temperatures of the object table and the printer head are met, the printing will continue.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

For example, although the 3D printer introduced in the embodiments above uses a touch screen and no physical keys or buttons are provided for the printer control, those skilled in the art would no doubt realize that other types of control means and display means may also be used. For example, it is possible to use a traditional LCD screen without touch control, accompanied by a keypad or control panel to realize controlling of the 3D printer. Likewise, a touchscreen on a portable device in wired or wireless communication with the control can be operated by means of an “app” that the user can utilize to carry out all the functions described above.

In the object table of the 3D printer, polyimide heating film is described as the resistive heater for the object table. However, other suitable thin film rather than the PI film can also be used as long as it can be used to produce heat. Also, the composition of the glass and its thickness may also be changed, although the borosilicate glass with a 3 mm thickness is described above as examples.

What is claimed is:

1. A 3D printer, comprising:
a) a frame;
b) a printing head connected to said frame and movable with respective to said frame; and
c) an table assembly connected to said frame; said table assembly comprising an object table adapted to support an object to be printed during a printing operation; wherein said table assembly is adapted to move relative to said frame at least
between a storage position and an operational position.

2. The 3D printer of claim 1, wherein said frame defines a three-dimensional form factor;
in said operational position, said table assembly extending beyond the form factor of said frame; in said storage position, said table assembly being substantially received within said form factor of said frame.

3. The 3D printer of claim 2, wherein said table assembly is defined by at least a first table dimension; said form factor of said frame defined at least by a first frame dimension and a second frame dimension; when said table assembly is in said storage position, said first table dimension being parallel to said first frame dimension and shorter than said first frame dimension; when said table assembly is in said operational position, said first table dimension being parallel to said second frame dimension and longer than said second frame dimension.

4. The 3D printer of claim 3, wherein said table assembly is rotatable with respect to said frame; said frame comprising a top plate, a base plate, and at least one side wall;
in said storage position said table assembly being substantially parallel to said side wall of said frame; in said operational position said table assembly being substantially parallel to and extending beyond said base plate of said frame.

5. The 3D printer of claim 4, wherein said table assembly is connected to said frame by two hinges;, said table assembly further comprising a table base on which said object table is supported; said two hinges coupled to said table base on two lateral edges thereof; said lateral edges being parallel to said first table dimension.

6. The 3D printer of claim 5, wherein on said two lateral edges of said table base, there are configured two grooves respectively; said hinges engaged with said grooves and being adapted to slide in said grooves, thereby allowing said table base to move linearly with respect to said hinges.

7. The 3D printer of claim 6, wherein said hinges are configured to allow sliding of said hinges in said grooves only when said table base is rotated relative to said hinges to a predetermined angle.

8. The 3D printer of claim 7, wherein each of said hinges further comprises a hinge pin and a stopping member fixed to said hinge pin; said table base rotatable with respect to said stopping member; said stopping member placed outside of said groove and being incapable of sliding in said groove when said table base is rotated relative to said stopping member to an angle different from said predetermined angle; said stopping member received inside said groove and being capable of sliding in said groove when said table base is rotated relative to said stopping member to said predetermined angle.

9. The 3D printer of claim 8, wherein at least a part of said stopping member has a cross-section in trapezoidal shape.

10. The 3D printer of claim 8, wherein said hinge pin is a screw.

11. The 3D printer of claim 4, further comprising a locking device coupled between said table assembly and said frame to lock said table assembly from moving relative to said frame.

12. The 3D printer of claim 11, wherein said table assembly further comprises a table base on which said object table is supported; said locking device comprising a locking pin which is movably received within through holes formed on said frame and said table base respectively; said locking pin capable of moving into or leaving said through hole of said table base to enable locking and unlocking of said table assembly.

13. The 3D printer of claim 1, further comprising a handle configured on said frame for a user to carry said 3D printer.

14. The 3D printer of claim 1, further comprising a touch screen; said touch screen connected to a controller of said 3D printer.

15. The 3D printer of claim 1, further comprising a storage device adapter adapted to connect to an external storage device.

16. The 3D printer of claim 15, wherein said storage device adapter is a SD card reader.

17. The 3D printer of claim 15, wherein said storage device adapter is connected to a controller of said 3D printer; said controller capable of reading 3D model files from said storage device for printing by said 3D printer.

18. The 3D printer of claim 1, wherein said printing head comprises:
a) a heating chamber for melting filament fed into said printing head;
b) a nozzle connected to and in communication with said heating chamber; said nozzle configured to output said melted filament;
c) an active cooling device coupled to said heating chamber; and
d) a passive cooling device coupled to said heating chamber.

19. The 3D printer of claim 18, wherein said active cooling device is a fan.

20. The 3D printer of claim 19, wherein said fan is configured to face directly said passive cooling device.

21. The 3D printer of claim 18, wherein said passive cooling device is a heat sink directly connected to said heating chamber.

22. The 3D printer of claim 21, wherein said heat sink has generally a cylindrical shape.

23. The 3D printer of claim 1, wherein said object table comprises:
a) a first layer of non-deformable material; said first layer adapted to support directly an object to be printed by said 3D printer; and
b) a second layer of heating material placed underneath said first layer; said heating material connected to a power source to generate heat required for keeping said object on a fixed location on said object table.

24. The 3D printer of claim 23, wherein said non-deformable material is thermal conductive.

25. The 3D printer of claim 24, wherein said non-deformable material is borosilicate glass.

26. The 3D printer of claim 25, wherein said borosilicate glass has a thickness of 3 mm.

27. The 3D printer of claim 23, wherein said heating material is a thin film.

28. The 3D printer of claim 27, wherein said heating material is polyimide heating film.

29. A method of configuring a 3D printer from a storage state to an operational state, comprising:
a) unlocking a table assembly of said 3D printer which is in a storage position from a frame of said 3D printer; said frame comprising a top plate, a base plate, and at least one side wall; said table assembly being substantially parallel with said side wall of said frame in said storage position;
b) rotating said table assembly with respect to said frame until said table assembly becomes substantially parallel with said base plate of said frame;
c) linearly moving said table assembly to an operational position; and
d) locking said table assembly in said operational position.

30. The method of claim 29, wherein said table assembly is locked to said frame in said storage position by a locking device which is adapted to be actuated by a user.

31. The method of claim 30, wherein said table assembly further comprises a table base on which said object table is supported; said locking device comprising a locking pin; said locking pin movably received within thorough holes formed on said frame and said object table respectively; in said unlocking, said user moving said locking pin to leave said thorough hole of said table base to enable unlocking of said table assembly.

32. The method of claim 29, wherein said table assembly further comprises a table base on which said object table is supported; said table base is connected to said frame by two hinges, said two hinges coupled to said table base on two lateral edges thereof.

33. The method of claim 32, wherein on said two lateral edges of said table base, there are configured two grooves respectively; said hinges engaging with said grooves and being adapted to slide in said grooves; in said moving, said table base being moved by said user linearly with respect to said hinges.

34. The method of claim 33, wherein each of said hinges further comprises a hinge pin and a stopping member fixed to said hinge pin; said stopping member being rotatable with respect to said groove; during said rotating, said stopping member placed outside of said groove and being incapable of sliding in said groove when said object table is not rotated to an angle to be substantially parallel to said base plate; said stopping member received inside said groove and being capable of sliding in said groove in said moving, when said object table is rotated to be substantially parallel to said base plate.

35. The method of claim 34, wherein at least a part of said stopping member has a cross-section in trapezoidal shape.

36. The method of claim 34, wherein said hinge pin is a screw.

37. A method of configuring a 3D printer from an operational state to a storage state, comprising:
a) unlocking a table assembly of said 3D printer which is in a operational position; a frame of said 3D printer comprising a top plate, a base plate, and at least one side wall; said table assembly being substantially parallel with said base plate of said frame in said operational position;
b) linearly moving said table assembly from said operational position to an intermediate position;
c) rotating said object table with respect to said frame from said intermediate position, until said object table becomes substantially parallel with said side wall of said frame; and
d) locking said object table in said storage position.

38. The method of claim 37, wherein said table assembly is locked to said frame in said storage position by a locking device which is adapted to be actuated by a user.

39. The method of claim 38, wherein said table assembly further comprises a table base on which said object table is supported; said locking device comprising a locking pin; said locking pin movably received within through holes formed on said frame and said table base respectively; in said unlocking, said user moving said locking pin to enter said through hole of said table base to lock said table assembly.

40. The method of claim 37, wherein said table assembly further comprises a table base on which said object table is supported; said table base is connected to said frame by two hinges, said two hinges coupled to said table base on two lateral edges thereof.

41. The method of claim 40, wherein on said two lateral edges of said table base, there are configured two grooves respectively; said hinges engaging with said grooves and being adapted to slide in said grooves; in said moving, said table base being moved by said user linearly with respect to said hinges.

42. The method of claim 41, wherein each of said hinges further comprises a hinge pin and a stopping member fixed to said hinge pin; said stopping member being rotatable with respect to said groove; during said rotating, said stopping member placed outside of said groove and being incapable of sliding in said groove when said object table is not rotated to an angle to be substantially parallel to said base plate; said stopping member received inside said groove and being capable of sliding in said groove in said moving, when said table base is rotated to be substantially parallel to said base plate.

43. The method of claim 42, wherein at least a part of said stopping member has a cross-section in trapezoidal shape.

44. The method of claim 42, wherein said hinge pin is a screw.

45. A printer head of a 3D printer, comprising:
a) a heating chamber for melting filament fed into said printer head;
b) a nozzle connected to and in communication with said heating chamber; said nozzle configured to output said melted filament;
c) an active cooling device coupled to said heating chamber; and
d) a passive cooling device coupled to said heating chamber.

46. The printer head of claim 45, wherein said active cooling device is a fan;

47. The printer head of claim 46, wherein said fan is configured to face directly said passive cooling device.

48. The printer head of claim 45, wherein said passive cooling device is a heat sink directly connected to said heating chamber.

49. The printer head of claim 48, wherein said heat sink has generally a cylindrical shape.

50. An object table of a 3D printer, comprising:
a) a first layer of non-deformable material; said first layer adapted to support directly an object to be printed by said 3D printer; and
b) a second layer of heating material placed underneath said first layer; said heating material connected to a power source to generate heat required for keeping said object on a fixed location on said object table.

51. The object table of claim 50, wherein said non-deformable material is thermal conductive.

52. The object table of claim 51, wherein said non-deformable material is borosilicate glass.

53. The object table of claim 52, wherein said borosilicate glass has a thickness of 3 mm.

54. The object table of claim 50, wherein said heating material is a thin film.

55. The object table of claim 54, wherein said heating material is polyimide heating film.

56. A method of resuming breakpoint printing in a 3D printer, comprising:
a) stopping printing during a printing operation of a 3D object;
b) saving a set of printing parameters into a memory of said 3D printer; said set of printing parameters comprising temperature of said printing head and three-dimensional coordinate of said printing head;
c) making said 3D printer power off;
d) making said 3D printer power on any period of time after said making said 3D printer power off;
e) reading said set of printing parameters from said memory and configuring said printing head so that said printing head is located at said three-dimensional coordinates and is at said temperature; and
f) resuming printing of said 3D object.

57. The method of claim 56, wherein said printing parameter further comprises surface temperature of an object table of said 3D printer.
